(19) United States
(12) Patent Application Publication
(10) Pub. No.: US 2018/0095760 A1
(43) Pub. Date: Apr. 5, 2018

(54) INSTRUCTION SET FOR VARIABLE LENGTH INTEGER CODING

(71) Applicants: James D. Guilford, Northborough, MA (US); Vinodh Gopal, Westborough, MA (US)

(72) Inventors: James D. Guilford, Northborough, MA (US); Vinodh Gopal, Westborough, MA (US)

(21) Appl. No.: 15/281,380

(22) Filed: Sep. 30, 2016

(51) Int. Cl. G06F 9/30

(52) U.S. Cl. CPC G06F 9/30149; G06F 9/30123; G06F 9/3016

(57) ABSTRACT

Instruction sets for variable length integer (varint) coding and associated methods and apparatus. The instructions sets include instructions for encoding and decoding varints, and may be included as a part of an instruction set architecture (ISA) for processors architectures such as x86 and Arm-based architectures, as well as other ISAs. In one aspect, the instructions include, a varint size encode instruction to encode a size of a varint, a varint encode instruction to encode a varint, a varint size decode instruction to decode a size of an encoded varint, and a varint decode instruction to decode an encoded varint. Varint encode size and encode instructions may be combined in a single instructions. Similarly, varint decode size and decode instructions may be combined in a single instruction. In one aspect, the instructions use a variable-length quantity (VLQ) encoding scheme under which varints are encoded into one or more VLQ octets.

### BACKGROUND INFORMATION

Companies such as Google, Facebook, Microsoft, and Amazon process data at massive scales. Computing platforms for cloud computing and large internet services are often hosted in large data centers, referred to as warehouse-scale computers (WSCs). The design challenges for such warehouse-scale computers are quite different from those for traditional servers or hosting services, and emphasize system design for internet-scale services across thousands of computing nodes for performance and cost-efficiency at scale. A significant portion of their data processing relates to processing large integers.

Recently, researchers at Google published a paper, (Kanev, Svilen, et al. “Profiling a warehouse-scale computer.” 2015 ACM/IEEE 42nd Annual International Symposium on Computer Architecture (ISCA). IEEE, 2015), where they reported workload profiling information on a range of Google production clusters over approximately three years. While the researchers found some hotspot behavior within applications, they identified common procedures across applications that constitute a significant fraction of total datacenter cycles. Most of these hotspots are in functions unique to performing computation that transcends a single machine—components that are termed “datacenter tax,” such as remote procedure calls, protocol buffer serialization and compression. The researchers postulated that such “tax” presents interesting opportunities for microarchitectural optimizations (e.g., in- and out-of-core accelerators) that can be applied to future datacenter-optimized server systems-on-chip (SoCs).

As shown in FIG. 1, 22-27% of WSC cycles are spent in difference components of datacenter tax. Among this is protocol buffer processing and management. According to the aforementioned paper, Protocol buffers are the common language for data storage and transport inside Google. One of the most common idioms in code that targets WSCs is serializing data to a protocol buffer, executing a remote procedure call while passing the serialized protocol buffer to the remote callee, and getting a similarly serialized response back that needs deserialization. The term “serializing” refers to converting structured data to a byte stream, usually either for storage or for communication. The inverse operation is called “de-serializing,” although Google calls it “parsing.” The serialization/deserialization code is generated automatically by the protobuf compiler, enabling programmers to interact with native classes in their language of choice. Generated code is the majority of the protobuf portion shown in FIG. 1.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a graph illustrating levels of datacenter “tax” based on measurements conducted by Google on its servers;

FIG. 2 is a diagram illustrating an encoding format used for encoding a variable length quantity (VLQ) byte;

FIGS. 3a and 3b are diagram illustrating VLQ encoding, wherein FIG. 3a corresponds to encoding an integer using a Big endian byte order, and FIG. 3b corresponds to an encoding of an integer using a Little endian bye order;

FIG. 4 is a diagram illustrating the result of a varint encode size instruction applied to a varint of 106903;

FIGS. 5a-5c are diagrams illustrating various operations relating to execution of a varint encode instruction applied to is the varint 106903;

FIG. 6 is a diagram illustrating how an 8-byte integer is encoded using 10-bytes under one embodiment of a varint encode instruction using VLQ encoding;

FIG. 7 is a diagram illustrating a process for decoding the size of the varint 106903 encoded using the operations shown in FIGS. 5a-5c;

FIG. 8a-8c are diagrams illustrating a process for decoding the varint 106903 encoded using the operations shown in FIGS. 5a-5c;

FIG. 9 is a schematic block diagram illustrating an example of an Arm-based microarchitecture;

FIGS. 10a-10d are diagrams illustrating an example of generating a byte-packed encoded varint byte stream using Arm-based varint encoding instructions, wherein

FIG. 10a illustrates operations performed in encoding a first varint 10592663, FIG. 10b illustrates operations performed in encoding a second varint 105926632979112352, FIG. 10c illustrates operations performed in encoding a third varint 9776547, and FIG. 10d illustrates operations performed in encoding a fourth varint 7039567833107374484; and

FIGS. 11a-11d are diagrams illustrating an example of decoding the byte-packed encoded varint byte stream generated in FIGS. 10a-10d using Arm-based varint decoding instructions, wherein FIG. 11a illustrates operations performed in decoding a first encoded varint 10592663, FIG. 11b illustrates operations performed in decoding a second encoded varint 105926632979112352, FIG. 11c illustrates operations performed in decoding a third encoded varint 9776547, and FIG. 11d illustrates operations performed in decoding a fourth encoded varint 7039567833107374484.

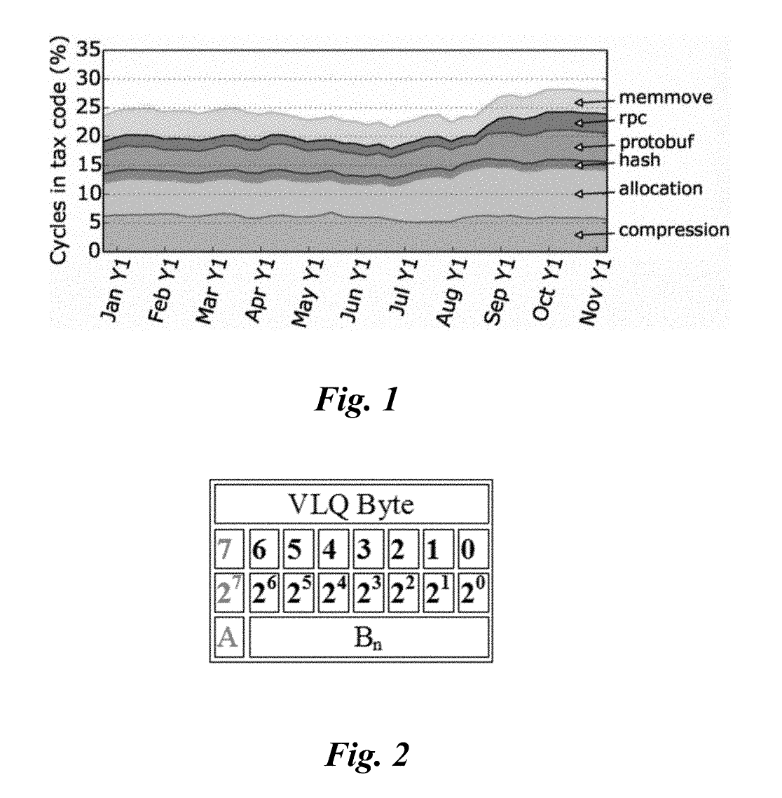

### DETAILED DESCRIPTION

Embodiments of instruction sets for variable length integer coding and associated methods and apparatus are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implementation, purpose, etc.

Protobuf is designed to be fast and small, and is widely used at Google. The actual performance is in a sense doubly data dependent. That is, it depends on the actual data being serialized, but it also depends on the data format being used. Accordingly, some formats are faster than others, and for a given format, some data will be faster than other data.

The basic paradigm of Protocol Buffers is that the user defines a number of “messages,” where each “message” describes the format of some data structure. These message descriptions are similar to XML schemas. A compiler then compiles these messages into code, which for C++ results in a C++ class for each message type. Similarly, for Java there would be a Java class for each message type.

To serialize data, the application copies its data into a class instance, and then tells it to serialize itself (via that class' serialization method). To return the serialized data to its original form (deserialization), the application can parse a data stream into the class instance, and then query it as to what data was obtained.

Roughly speaking at a high level, there are two types of data that are written to/parsed from the stream: integers and strings. Integers are usually written as “varints” or variable-length integers. Varints are written as between 1 and 10 bytes, depending on the value being written.

Strings are written as a varint for the length, followed by the bytes of the string. So in a sense, the serialization process can be considered to have three components:

1. Deciding what data is present and should be written (e.g. miscellaneous control logic).

2. Writing varints.

3. Memcopying strings.

Parsing a data stream is similar, except that there is also a component for allocating memory that may be invoked.

There are two related sets of methods, one which writes the serialized data, and one which merely computes the length of the former. When serializing into a memory buffer, a first traversal computes the size of the serialized data, and then after checking the size of the buffer, a second pass actually writes it.

In this disclosure, we focus on the problem of reading/writing varints, and provide a comprehensive Instruction Set Architecture (ISA) definition to accelerate the processing.

### Overview of Variable Integer Encoding

A variable length quantity (VLQ) is a code that uses an arbitrary number of bytes to represent an arbitrarily large integer. It is essentially a base-128 representation of an unsigned integer with the addition of the eighth bit to mark continuation of bytes. As shown in FIG. 2, the encoding assumes an octet/byte where the most significant bit is reserved to indicate whether another VLQ byte follows. If A is 0, then this is the last VLQ byte of the integer. If A is 1, then another VLQ byte follows. B is a 7-bit number [0x00, 0x7F] and n is the position of the VLQ byte where BO is least significant.

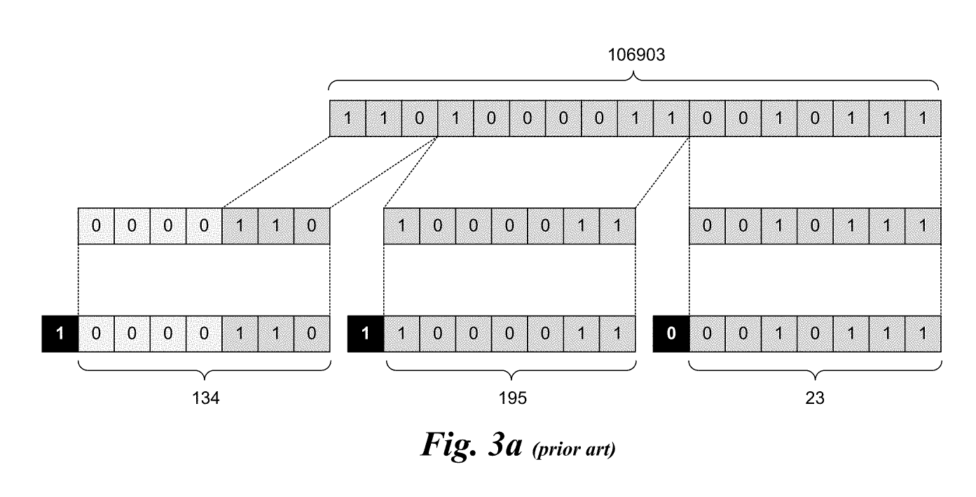

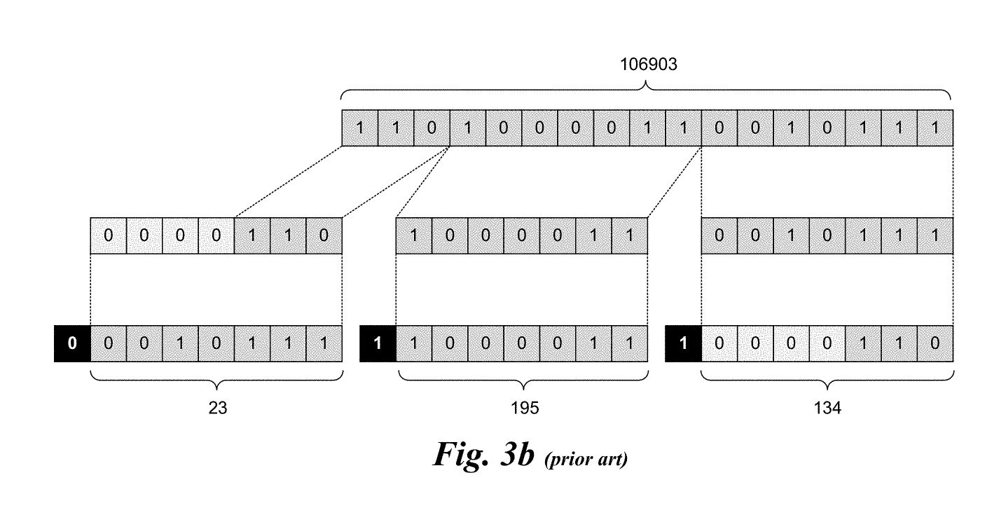

Wikipedia (https://en.wikipedia.org/wiki/Variable-length_quantity) shows an example of a uintvar (a Big endian version) corresponding to a conversion of the integer 106903, which is replicated in FIG. 3a. In the Big endian version, the most-significant byte is transmitted first (134), and the least-significant byte is transmitted last (23). It is noted that the Google protobuf varint uses a Little endian version, where the least significant group of 7 bits are encoded in the first byte and the most significant group bits are in the last byte. An example of a Little endian uintvar for 106903 is shown in FIG. 3b.

### ISA Definition Summary for Varint

In one embodiment, the varint instructions can be defined as two sets of two: two instructions for encode and two instructions for decode. Within each pair, one instruction does the encoding, and one instruction calculates the size of the encoding. Within each instruction, the following shows a pseudocode description of the instruction definition, which can be implemented as circuits or combination of special circuits and existing micro operations (uops) with a microcode-flow using techniques that are well-known in the processor arts. The actual implementation will depend on the target microarchitecture and the performance/area tradeoffs.

LISTING 1 shows pseudocode for a 64-bit varint size encoding instruction, according to one embodiment.

LISTING 1

| | |
|---|---|
| varint64_encode_size | r64, r64 |

| | | |
|---|---|---|
| 1 | //dst, src | return a number <= 10 |

| | | |
|---|---|---|
| 2 | value = src \| 1; | // Logically OR (inclusive) with 0x0000 0000 0000 0001 |
| 3 | x = BSR(value); | // Bit-Scan-Reverse instruction/uop |
| 4 | x = (9*x + 73); | // If implemented as ucode, this can be done with LEA uop |
| 5 | dst = x / 64; | // fixed right shift by 6; optionally dst >> 6. |

The instruction employs two operands comprising 64-bit registers; a source (src) register and a destination (dst) register, with the src registers storing the varint to be encoded and the dst register being used to store the instruction's result, which corresponds to the size of the encoded varint in bytes. As shown in line 1, the instruction returns a number (length) that is less than or equal to 10 (bytes).

In line 2, the src bits are copied into a register and logically OR'ed on a bit-wise basis with 0x0000 0000 0000 0001, yielding a “value” that is either the same as the varint if the least significant bit (LSB) of the varint was a ‘1’, otherwise the value=varint+1. The operation in line 2 ensures at least one bit in value is set (i.e., a ‘1’).

Next, in line 3, a Bit-Scan-Reverse (BSR) instruction is performed on value. The BSR instruction searches the source operand (value operand) for the most significant set bit (‘1’ bit). If a most significant set bit is found, its bit index ‘x’ is stored in the destination operand (a register uses to store the value of ‘x’). In line 4, the value of x is set to 9 times x plus 73. As indicated by the comment in line 4, if implemented in ucode, this can be done with a Load Effective Address (LEA) uop. In line 5, the result of x divided by 64 is then written to the destination register. This results in a fixed right shift by 6 bits, which may optionally be implemented with a bit shift instruction operating on the value in the destination register (e.g., dst >>6).

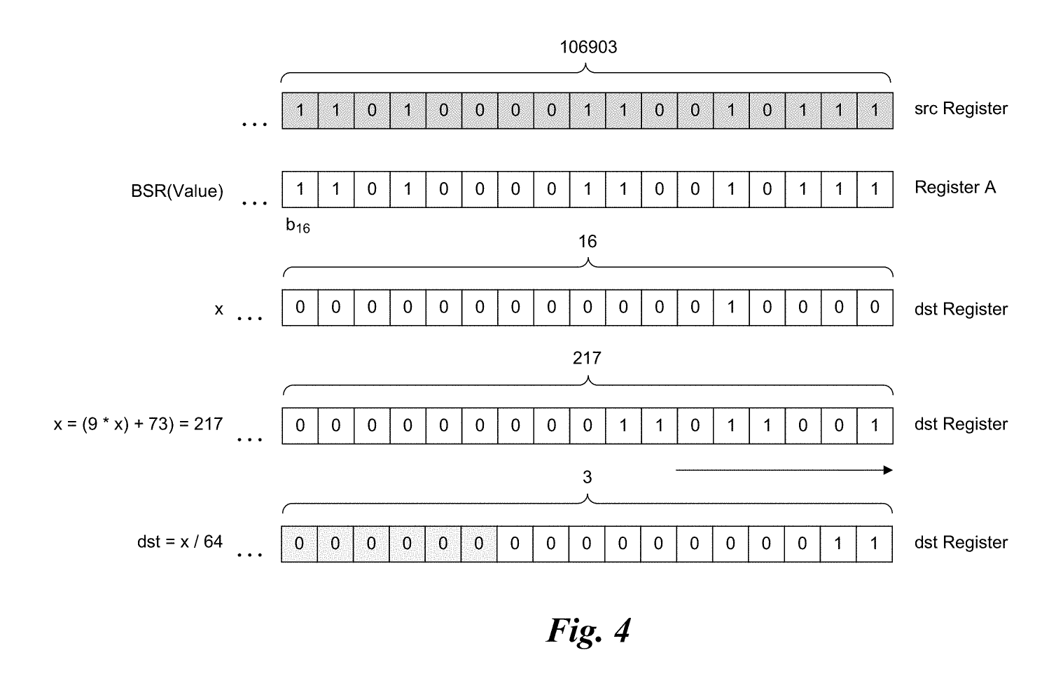

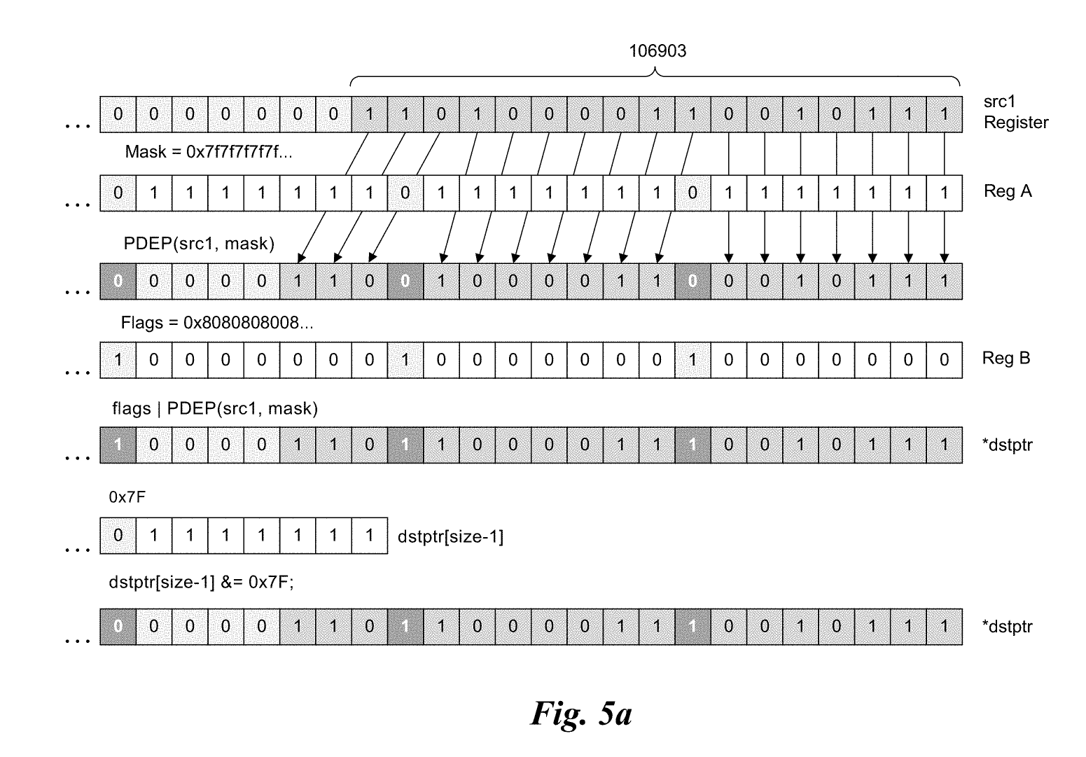

FIG. 4 shows the result of the varint64_encode_size instruction applied to a varint of 106903. The value of 107903 is stored in the src register in binary form. For simplicity and clarity the extra bits that would lie to the left of the binary values in FIG. 4 are not shown. The value of 107903 is copied into a Register A, and the BSR instruction is executed, resulting in a value of 16, which corresponds to the bit index ‘x’ of the most significant bit (x=16). This value is then written in binary to the dst register. The value in the dst register (‘x’) is then multiplied by 9 plus 73, which results in a value for ‘x’ of 217 being written in binary to the dst register. The bits in the dst register are then shifted by 6 positions to the right (the result of dividing ‘x’ by 64). The final result is a binary value of {1 1} or 3 in decimal. Returning to FIG. 3b, the value of 107903 has a length of 3 bytes using the uintvar VLQ encoding.

LISTING 2 shows the pseudocode for encoding a 64-bit varint instruction, according to one embodiment.

LISTING 2

| | |
|---|---|
| varint64_encode | m128, r64, RCX |

| 1 | // dstptr pointer to 128-bits, | |
|---|---|---|
| 2 | // r64 (or r128 e.g. XMM) src1, | |
| 3 | // r64 implicit register RCX or explicit src2 (if encoding permits) | |
| 4 | // 64-bit Constants Flags = 0x8080808080..., mask = 0x7f7f7f7f7f7f..., | |
| 5 | size = RCX; | |
| 6 | *dstptr = flags \| PDEP(src1, mask); | // PDEP instruction/uop (BMI₂) |

| | |
|---|---|
| 7 | *(dstptr+8) = flags \| PDEP(src1 >> 56, mask); |
| 8 | dstptr[size−1] &= 0x7F; |

This instruction uses three operands labeled m128, r64, and RCX. m128 is a pointer (dstptr) to a 128-bit destination address (in system memory). The varint value (src1) is stored in a 64-bit source (scr1) register. Optionally, it may be stored in a 128-bit source register. The size of the varint (determined above) is stored in the RCX register.

As shown in line 4, there are two 64-bit constants—a set of flags with a hexadecimal value of 0x8080808080 . . . , and a mask with a hexadecimal value of 0x7f7f7f7f7f7f . . . In line 5, the size operand is set to the size value in the RCX register.

Various embodiments herein employ Parallel bit deposit and extract instructions, respective called PDEP and PEXT. The PDEP and PEXT instructions are part of Bit Manipulation Instruction Set 2 (BMI2), introduced by INTEL® Corporation in its “Haswell” line of processors. They take two inputs; one is a source, and the other is a selector. The selector is a bitmap, such as a mask, used for selecting the bits that are to be packed or unpacked. PEXT copies selected bits from the source to contiguous low-order bits of the destination; higher-order destination bits are cleared. PDEP does the opposite, for the selected bits: contiguous low-order bits are copied to selected bits of the destination; other destination bits are cleared. This can be used to extract any bitfield of the input, and even do a lot of bit-level shuffling that previously would have been expensive. While what these instructions do is similar to a bit level gather-scatter SIMD instructions, PDEP and PEXT instructions (like the rest of the BMI instruction sets) operate on general-purpose registers.

In line 6, the flags bits are logically OR'ed (inclusive OR) on a bitwise basis with the result of PDEP instruction using the varint (src1) and mask as operands, and the result is written to the register pointed to by dstptr. PDEP uses a mask to transfer/scatter contiguous low order bits in the source operand into the destination. The PDEP instructions takes the low bits from the source operand and deposit them in the destination operand at the corresponding bit locations that are set in the mask. All other bits (bits not set in mask) in the destination are set to zero (i.e., cleared).

In line 7, the result of flags logically OR'ed with a PDEP instruction using the varint value (src1) bit shifted 56 bits to the right as one operand and the mask as the other operand is written to the location of the dstprt+8 bytes. In line 8 the bits in the byte in the register pointed to by dstptr at an index of [size-1] (in bytes) is logically AND'ed with the value 0x7F.

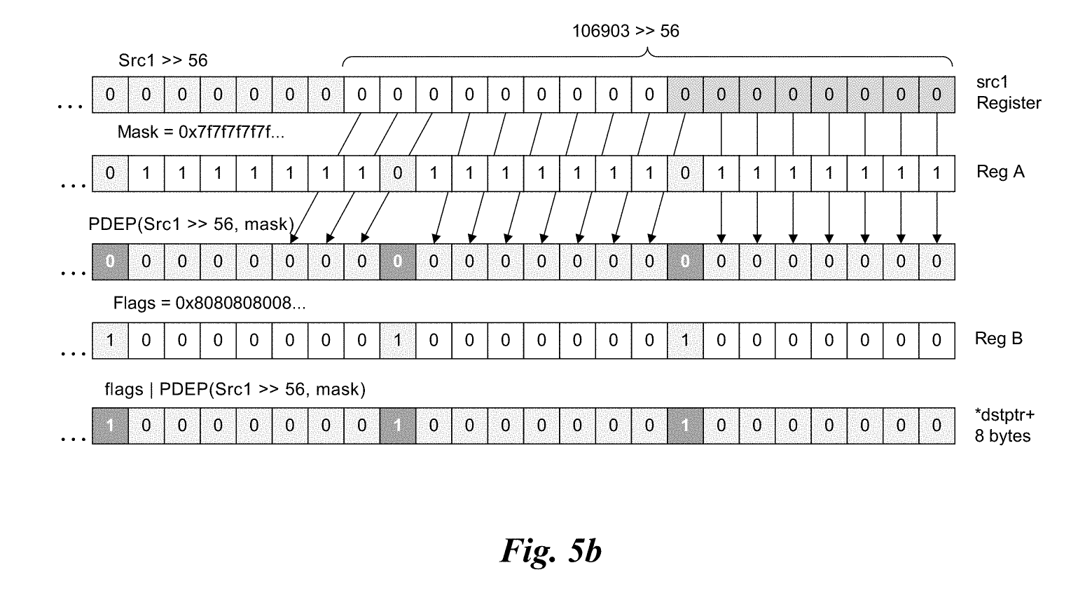

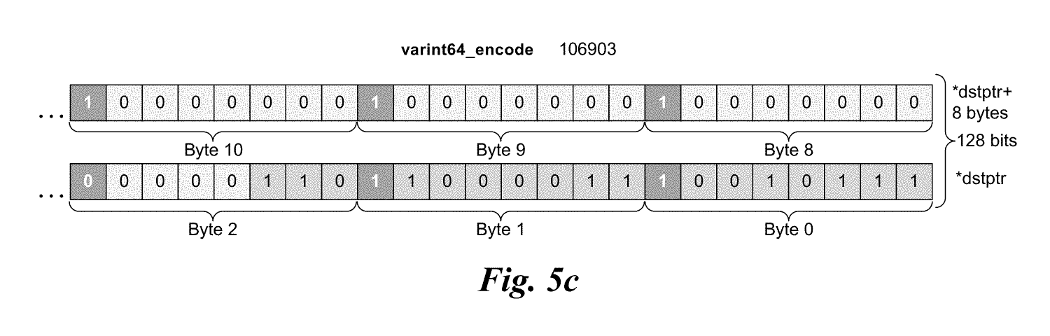

The 64-bit varint encoding process is illustrated in FIGS. 5a-5c, using the same varint=106903 in the example of FIG. 4. As illustrated in FIG. 5a, the PDEP(scrl, mask) instruction “scatters” the varint bits by inserting a ‘1’ at each position that has a bit value in the mask of ‘0’. Progressing through the various operations results in a bit encoding pointed to by *dstptr that is the same as the Little endian encoding of FIG. 3b.

FIG. 5b illustrates the operations performed in line 7. First, the scrl value is bit-shifted to the right 56 bits. The PDEP instruction is then applied to the bit-shifted value in scr1, using the mask 0x7f7f7f7f7f . . . as the second operand, resulting in PDEP(Src1>>56, mask). This value is logically OR'ed with the flags constant and written to the location pointed to by the dstptr+8 bytes.

The resulting 128-bit encoding is shown in FIG. 5c. For any varint that is less than 8 bytes long, the value for the upper 8 bytes will be 0x00000000, as illustrated by bytes 8, 9, and 10.

Another way to understand the encoding operations is to consider the values in each byte using hexadecimal (hex) notation, rather than at the individual bit level. The hex notation for the lower (bytes 7:0) at the various stages of the process are illustrated in TABLE 1 below. In hexadecimal notation, decimal 106903=0x1A197, as shown in the first row as the input value.

The high half (i.e. bytes 15:8) of the encoded value would just be 8080808080808080. Thus, the 128-bit encode value in hex would be:

8080808080808080808080808006C397

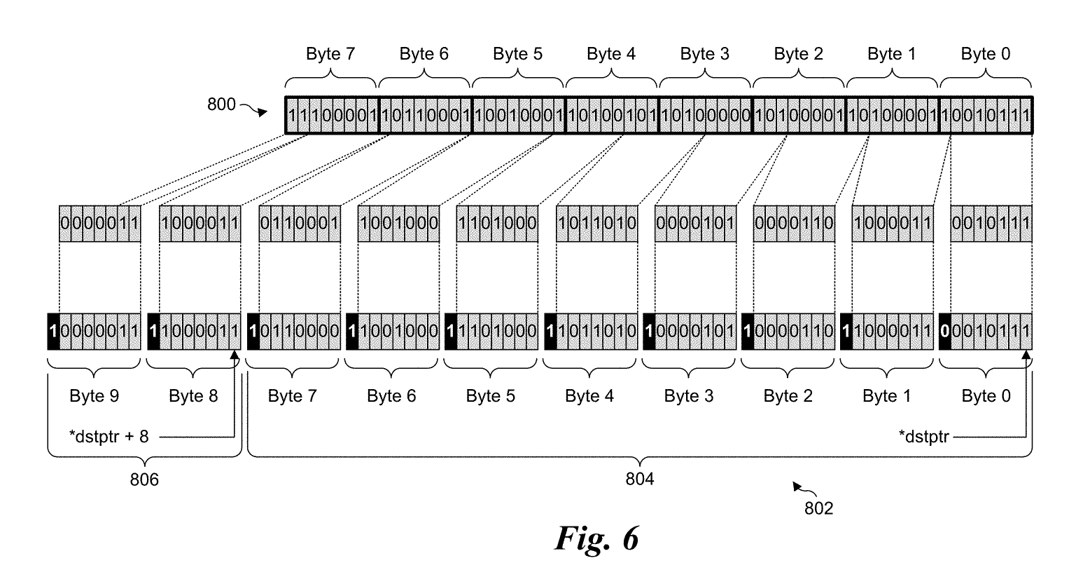

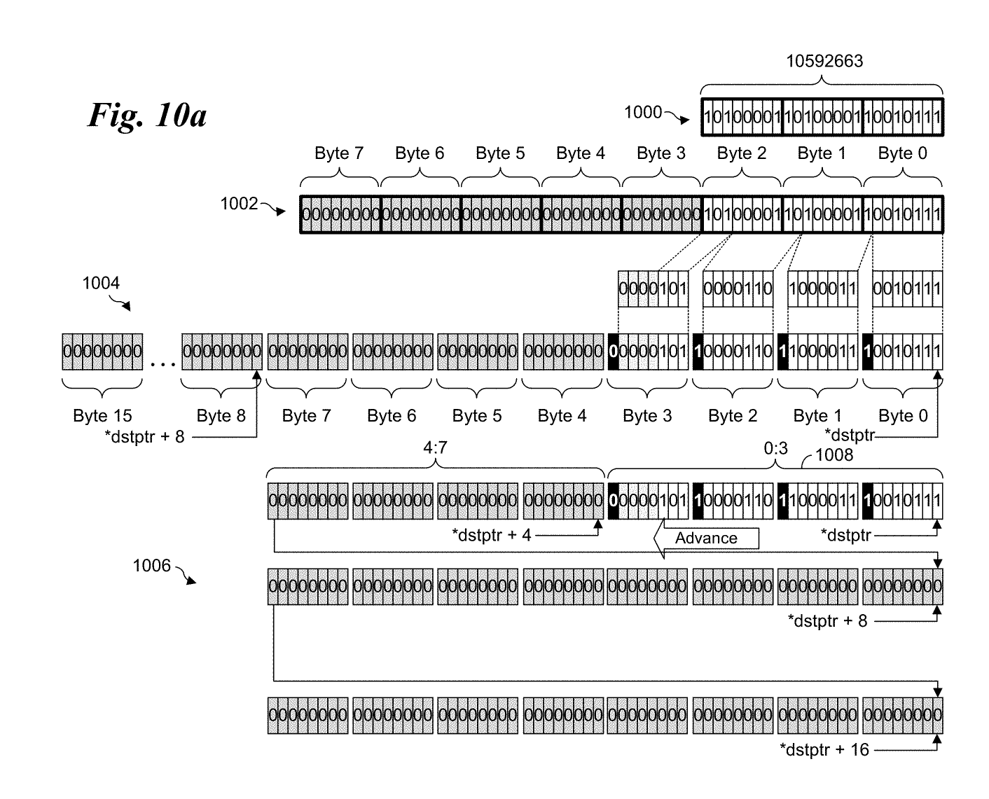

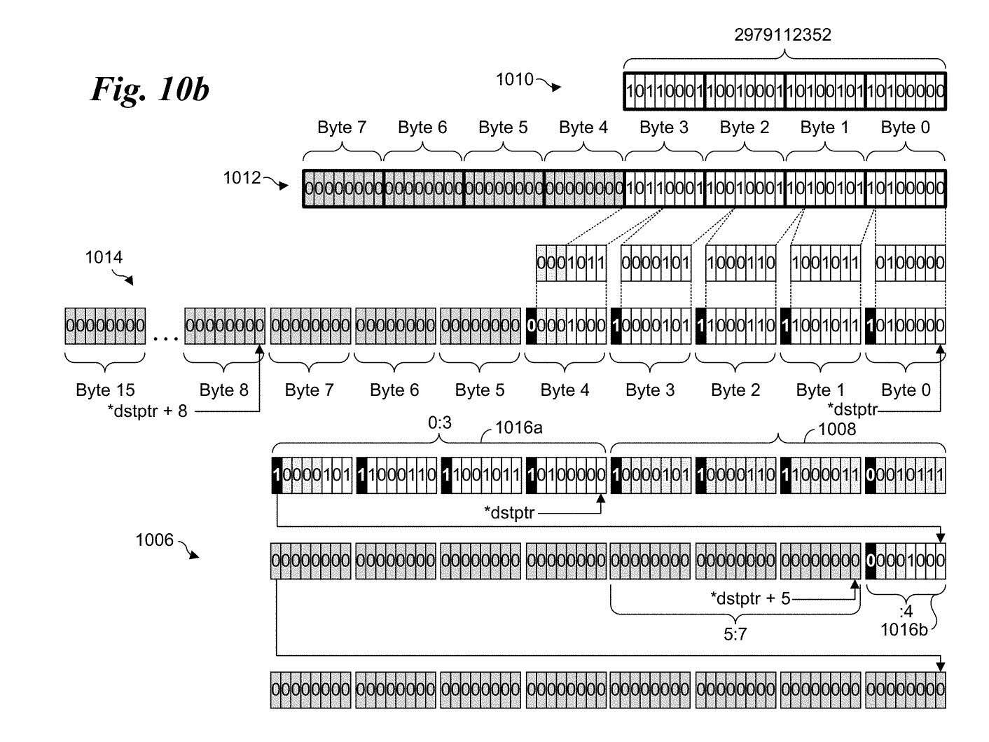

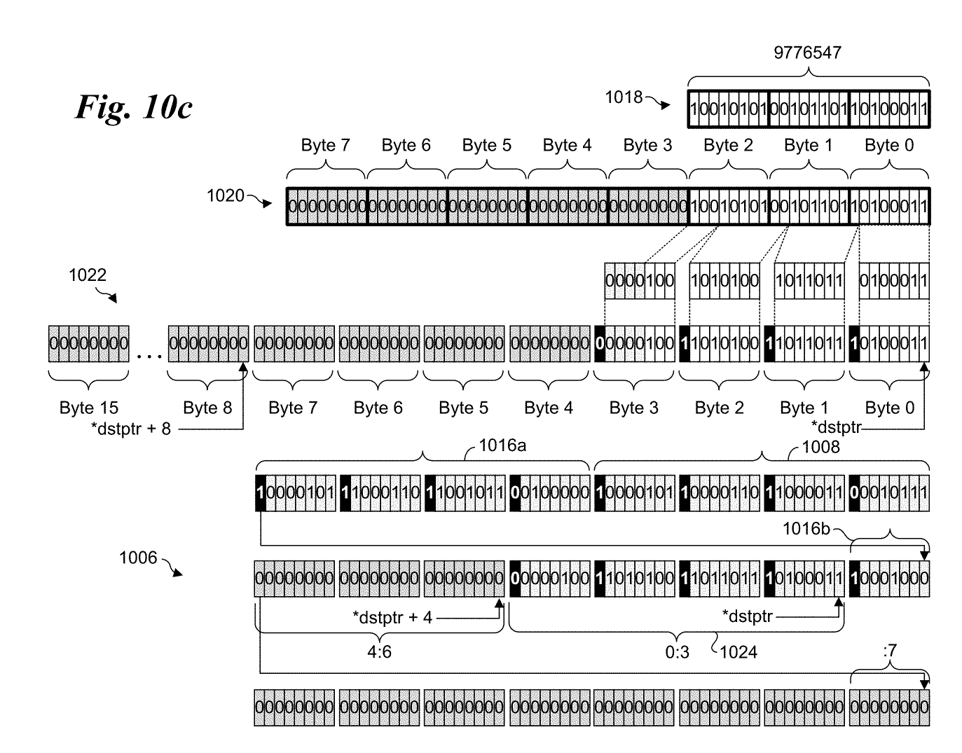

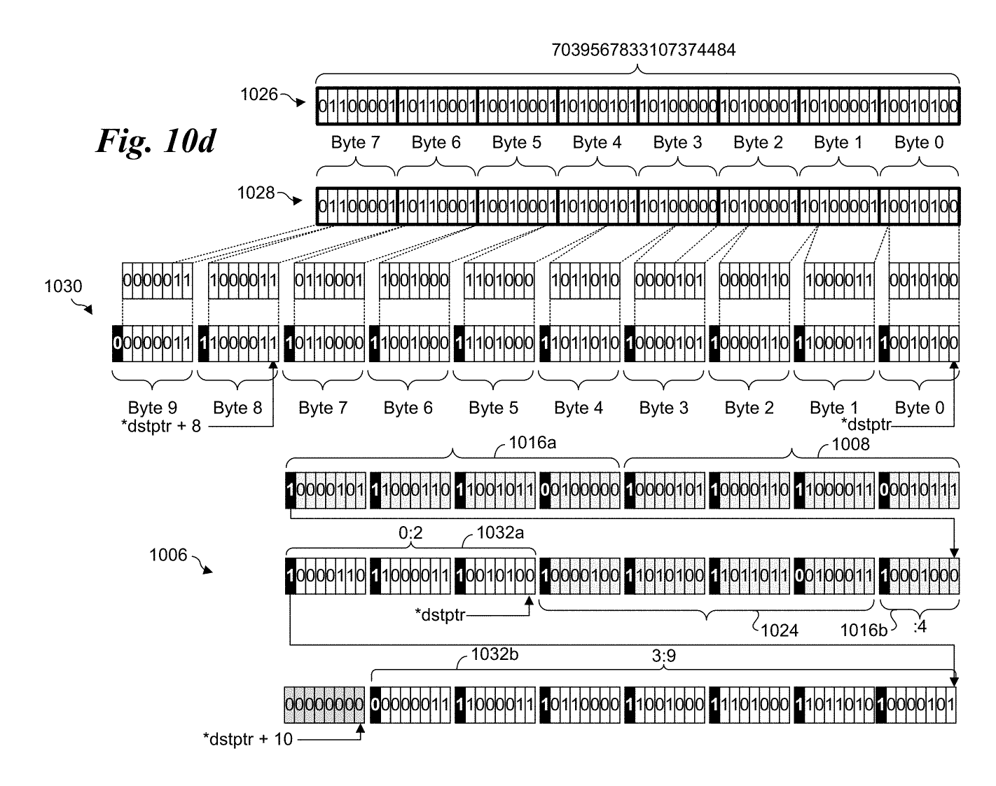

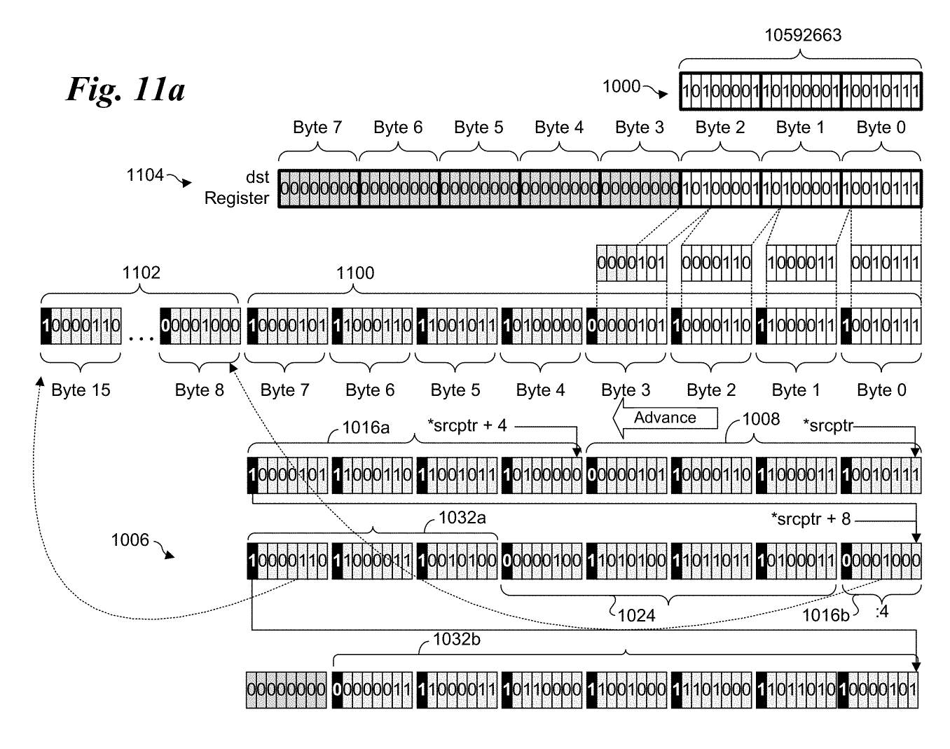

FIG. 6 shows the mapping between an unencoded varint 800 having a size of 8 bytes and its encoded format 802, having a size of 10 bytes. As shown, the bits of each of bytes 0:6 are mapped to corresponding bits in bytes 0:7 of encoded format 802, while the bits of byte 7 of varint 800 are mapped to corresponding bits in bytes 8:9 of encoded format 802, wherein the upper six bits of byte 9 will be cleared (‘0’). During encoding and decoding (described below), the encoded bytes 0:9 will be copied (or otherwise read from) a 128-bit storage location under which encoded bytes 0:7 will be located at the address pointed to by the dstprt and bytes 8:9 will be located at dstprt+8 bytes. Under embodiments in which a pair of sequential registers are used to store an encoded varint, bytes 0:7, which correspond to a lower portion 804 of the encoded varint will be stored in a first register having an address of the dstprt, and bits 8:9, which correspond to an upper portion of the encoded varint will be written to a second register having an address pointed to by the dstprt+8 bytes. The bits for bytes 10:15 in upper portion 806 (not shown) will depend on the bits values in varints following varint 800 in an encoded byte stream, as explained below with reference to FIG. 10.

Pseudocode corresponding to embodiments of the 64-bit varint size decode and varint decode instructions are shown in LISTING 3 and LISTING 4, respectively.

LISTING 3

| | | |
|---|---|---|
| varint64_Decode_size | r64, m128 | // Throws Fault |

| | | |
|---|---|---|
| 1 | //dst, srcptr pointer to 128-bit encoded varint | return a number <= 10 |

| | |
|---|---|
| 2 | for(size=1; size<=16; size++){ |

| | |
|---|---|
| 3 | if((srcptr[size−1] & 0x80)==0) break; |

| | |
|---|---|
| 4 | } |
| 5 | if (size > 10) return error // #GP |
| 6 | dst = size; |

Decoding returns encoded varints to their original values. The varint decode size instruction employs two operands—the first is the size, which will be written to a 64-bit destination (dst) register and the second is a pointer (srcptr) to a 128-bit location (address) in system memory at which the encoded varint is stored. As shown in lines 2-4, a loop is executed until the bits one of the bytes an encoded byte stream pointed to be srcptr when logically AND'ed with 0x80 (1000 0000b) equal 0 (0000 0000b). This will occur any time the most significant bit (bit 7) of a byte is cleared. Accordingly, the loop evaluates each byte in order (beginning at the byte pointed to by srcptr) until a byte with a cleared bit 7 is found, incrementing size for each loop iteration. The resulting value for size when the loop breaks is then written to the dst register, unless the size is greater than 10, which results in a general protection fault (#GP) error.

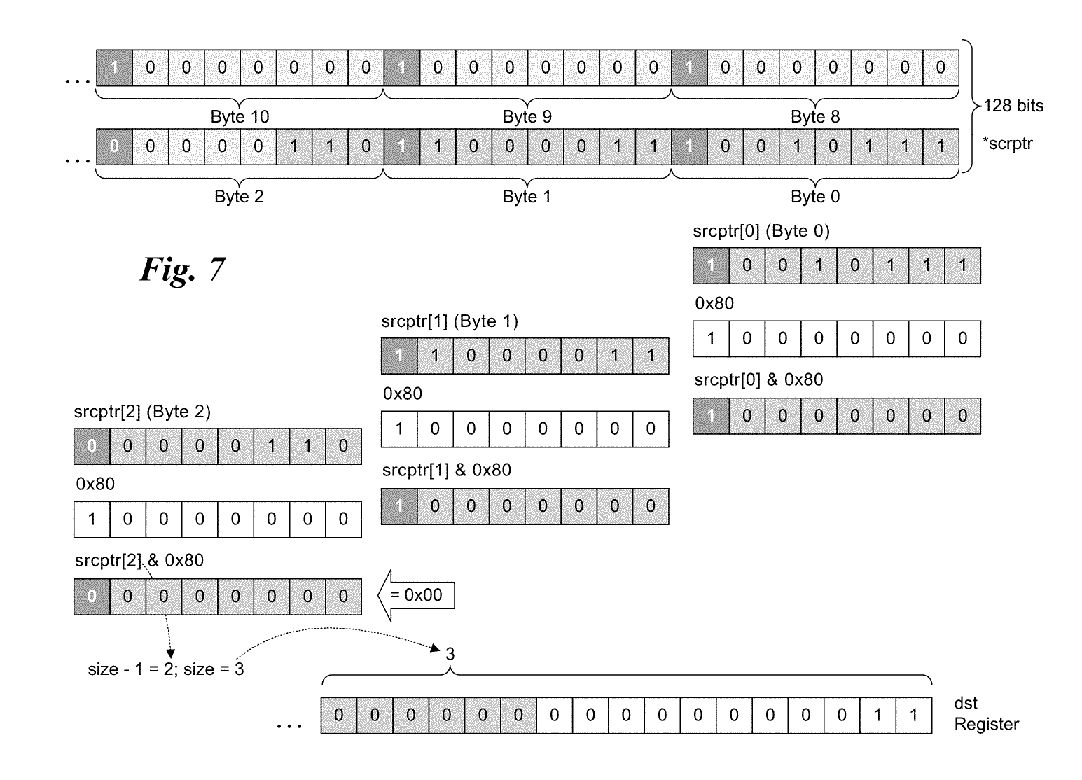

Operations corresponding to an example of decoding the size of the varint encoded above are illustrated in FIG. 7. The loop performs a byte-wise evaluation to find the first byte where the most significant bit (MSb) is ‘0’, e.g., the first byte having a bit pattern of 0XXX XXXX, beginning with byte 0, where ‘X’ represents a ‘1’ or a ‘0’ (i.e., a don't care bit). As illustrated in FIG. 7, the first byte that has a bit pattern of 0XXX XXXX is byte 2. Thus, the decoded size of the encoded varint is 3, which is written to the dst register.

LISTING 4

| | |
|---|---|
| varint64_Decode | r64, m128, RCX |

| | |
|---|---|
| 1 | // r64 (or r128 e.g. XMM) dst, |
| 2 | // srcptr pointer to 128-bits, |
| 3 | // r64 implicit register RCX or explicit src2 (if encoding permits) |
| 4 | // 64-bit Constants mask = 0x7f7f7f7f7f7f..., |
| 5 | size = RCX; |

| | | |
|---|---|---|
| 6 | m2\|\|m1 = 2⁽⁸*^{size)}−1 | // m1, m2 are 64-bit |
| 7 | value1 = m1 & PEXT(*srcptr, mask) | // PEXT instruction/uop (BMI₂) |

| | |
|---|---|
| 8 | value2 = m2 & PEXT(*srcptr+8, mask) |
| 9 | dst = (value2<<56) \| value1 |

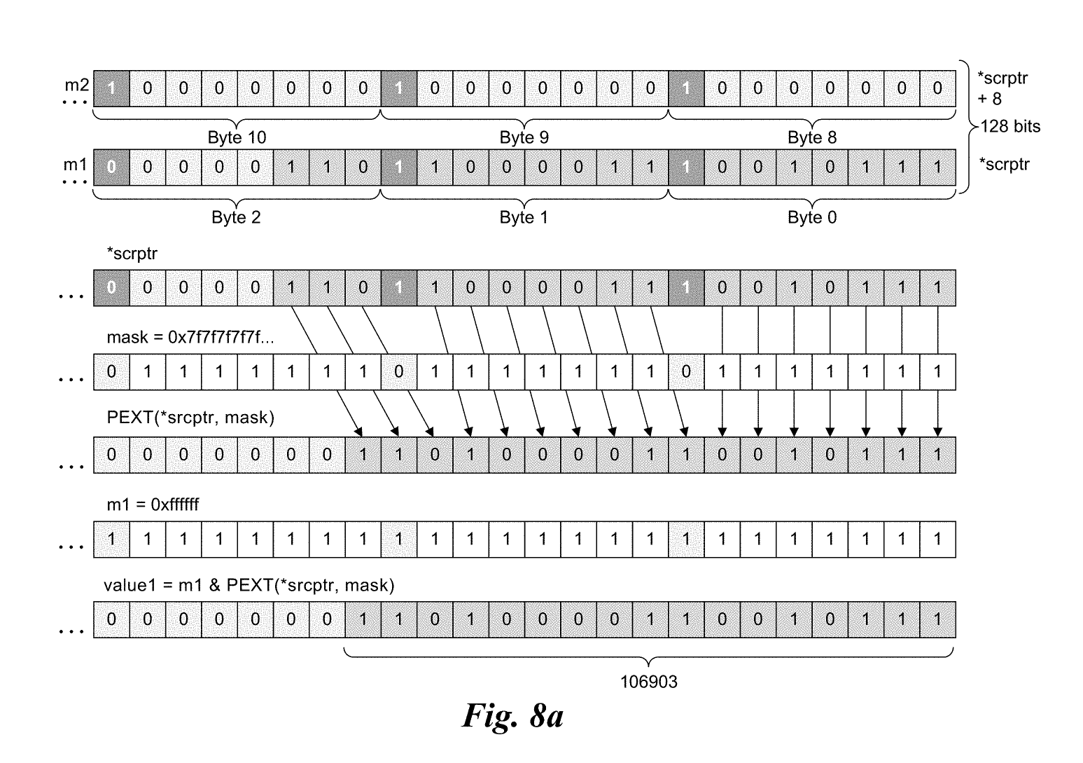

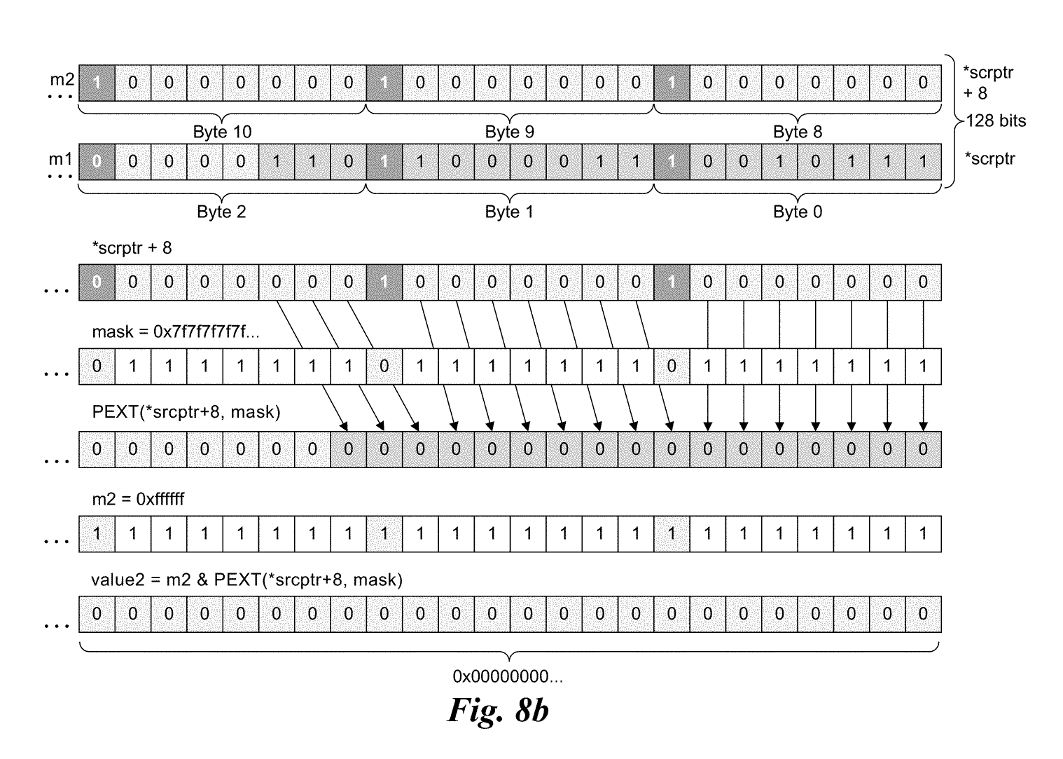

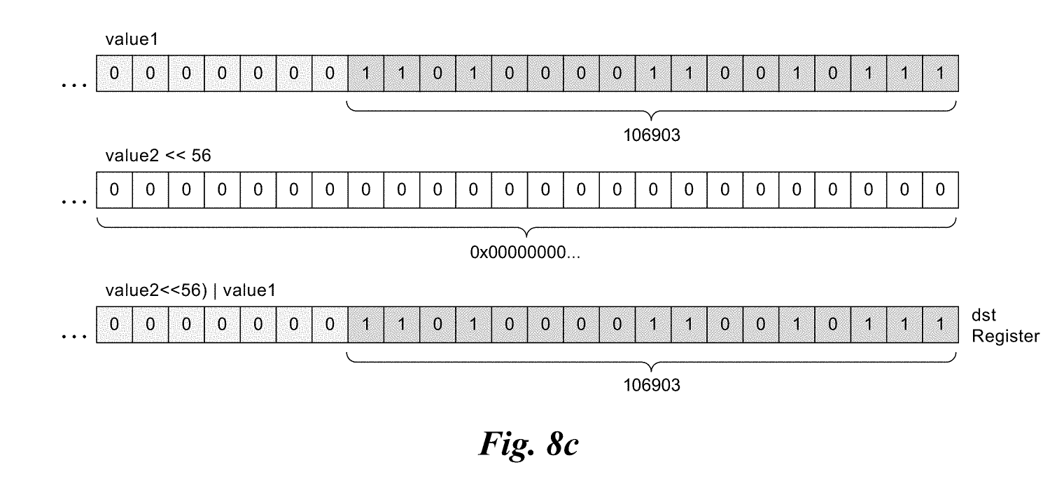

Operations relating to decoding a varint are illustrated in FIGS. 8a-8c. The operands include the decoded varint value, which is written to a 64-bit (or 128-bit) dst register, a pointer (scrptr) to the start of an 128-bit chunk of memory containing the encoded varint, and the RCX register in which the length of the varint is stored.

In line 6, each of 64-bit m1 and m2 values are set to 2^{(8*size)}−1. In the current example, the size is 3, and thus m1 and m2=16,777,215 decimal or 111111111111111111111111b or 0xffffff. In line 7, the bits for a value1 is determined using (in part), a PEXT (Parallel Bits Extract) instruction. The PEXT instruction is an instruction that is often paired with the PDEP instruction, and performs the reverse operation of PDEP, as illustrated in FIGS. 8a and 8b. The PEXT instruction uses a mask to transfer either contiguous or non-contiguous bits in the source operand to contiguous low order bit positions in the destination (in which the result is stored). For each bit set in the MASK, PEXT extracts the corresponding bits from the source operand and writes them into contiguous lower bits of the destination operand. The remaining upper bits of destination are zeroed.

As shown in FIG. 8a, each time a bit value of ‘0’ is encountered in the mask, the corresponding bit (i.e., having the same bit position) in the source operand pointed to by scrptr is skipped. The result of PEXT(*srcptr, mask) is then logically AND'ed with ml to obtain to obtain value1, as depicted by the bit pattern at the bottom of FIG. 8a.

FIG. 8b illustrates operations and corresponding data relating to line 8. This time the operations are performed on the upper eight bytes (15:8) pointed to by scrptr+8. The resultant value2 bit pattern is shown at the bottom of FIG. 8b.

FIG. 8c shows the operation of line 9, with the result corresponding to the decoded varint 106903 being written to the dst register. For simplicity, the upper byte bits are not shown, but they would be all 0's.

In addition to the foregoing two encode and two decode varint instructions, additional instructions may also be implemented in an ISA. In LISTING 5, the varint64_encode2 instruction writes m128 with the encoded value, and writes the size into RCX.

LISTING 5

| | |
|---|---|
| varint64_encode2 | m128, RCX, r64 |

| 1 | // dstptr pointer to 128-bits, | |
|---|---|---|
| 2 | // r64 (or r128 e.g. XMM) src1, | |
| 3 | // r64 implicit register RCX or explicit src2 (if encoding permits) | |
| 4 | // 64-bit Constants | Flags = 0x8080808080..., mask = 0x7f7f7f7f7f7f..., |
| 5 | value = src1 \| 1; | |
| 6 | x = BSR(value); | // Bit-Scan-Reverse instruction/uop |
| 7 | x = (9*x + 73); | // If implemented as ucode, this can be done with LEA uop |
| 8 | size = x / 64; | // fixed right shift by 6 |

| | | |
|---|---|---|
| 9 | *dstptr = flags \| PDEP(src1, mask); | // PDEP instruction/uop (BMI₂) |

| | |
|---|---|
| 10 | *(dstptr+8) = flags \| PDEP(src1 >> 56, mask); |
| 11 | dstptr[size−1] &= 0x7F; |
| 12 | RCX = size; |

LISTING 6 shows a variant that is all register-based.

LISTING 6

// Instruction writes register-pair <RAX:RDX> with encoded value, and writes size into
RCX

| | |
|---|---|
| varint64_encode2_reg | RAX, RDX, RCX, r64 |

| 1 | // RAX:RDX written with encoded value | |
|---|---|---|
| 2 | // r64 (or r128 e.g. XMM) src1, | |
| 3 | // r64 implicit register RCX or explicit src2 (if encoding permits) | |
| 4 | // 64-bit Constants | Flags = 0x8080808080..., mask = 0x7f7f7f7f7f7f..., |
| 5 | value = src1 \| 1; | |
| 6 | x = BSR(value); | // Bit-Scan-Reverse instruction/uop |
| 7 | x = (9*x + 73); | // If implemented as ucode, this can be done with LEA uop |
| 8 | size = x / 64; | // fixed right shift by 6 |

| | | |
|---|---|---|
| 9 | m2\|\|m1 = 2⁽⁸*^{size)-1}−1 | // m1, m2 are 64-bit |

| | |
|---|---|
| 10 | RDX = m1 & (flags \| PDEP(src1, mask)); // PDEP uop (BMI₂) |

| | |
|---|---|
| 11 | RAX = m2 & (flags \| PDEP(src1 >> 56, mask)); |

| | |
|---|---|
| 12 | RCX = size; |

The foregoing varint encode and decode instructions may be implemented in processors employing an x86 ISA. However, this is merely exemplary and non-limiting, as variants of the foregoing instructions may be implemented on various processor architectures. For example, consider the RISC-style Arm processor. The instructions are generally capable of 3 operands. They have integer scalar instructions that work on general-purpose registers (GPRs) (e.g., 16 or 32 registers), and vector/floating-point instructions that work on 128-bit SIMD (called Neon) registers.

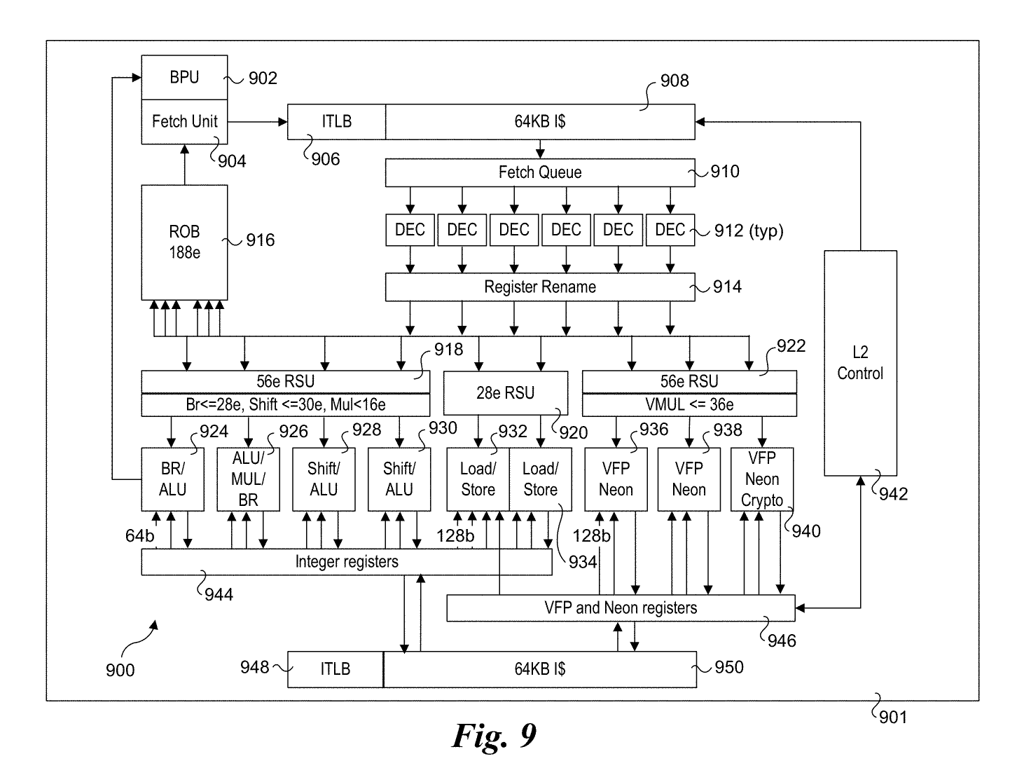

An example of a custom-core Arm processor architecture—the 900, is shown in FIG. 9. Microarchitecture 900 includes a branch prediction unit (BPU) 902, a fetch unit 904, an instruction translation look-aside buffer (ITLB) 906, a 64 KB (Kilobyte) instruction store 908, a fetch queue 910, a plurality of decoders (DECs) 912, a register rename block 914, a reorder buffer (ROB) 916, reservation station units (RSUs) 918, 920, and 922, a branch arithmetic logic unit (BR/ALU) 924, an ALU/MUL(Multiplier)/BR 926, shift/ALUs 928 and 930, and load/store blocks 932 and 934. Microarchitecture 900 further includes vector/floating-point (VFP) Neon blocks 936 and 938, and VFP Neon cryptographic block 940, an L2 control block 942, integer registers 944, 128-bit VFP and Neon registers 946, an ITLB 948, and a 64KB instruction store 950.

LISTING 7 shows pseudocode corresponding to one embodiment of a 64-bit varint encode size instruction using an Arm microarchitecture.

LISTING 7

| | |
|---|---|
| A64_varint64_encode_size_GPR | Xd, Xm // 64-bit GPR Registers |

| | | |
|---|---|---|
| 1 | //dst, src | return a number <= 10 |

| 2 | value = Xm \| 1; | |
|---|---|---|
| 3 | x = BSR(value); | // Bit-Scan-Reverse instruction/uop |
| 4 | x = (9*x + 73); | |
| 5 | Xd = x / 64; | // fixed right shift by 6 |

Note that we can also define the SIMD Vector 128-bit register variant as:

A64_varint64_encode_size_VFP Vd.2D, Vm.2D//computes the above in a pair of 64-bit lanes, high and low

LISTING 8 shows pseudocode corresponding to one embodiment of a 64-bit varint encode instruction using an Arm microarchitecture.

LISTING 8

| | |
|---|---|
| A64_varint64_encode_VFP | Vd.1Q, Vn.1D, Vm.1D |

| 1 | // Destination Vd is 128-bits, | |
|---|---|---|
| 2 | // Low 64-bits of 2 source operands Vn, Vm | |
| 3 | // 64-bit Constants Flags = 0x8080808080..., mask = 0x7f7f7f7f7f7f..., | |
| 4 | size = Vm; | |
| 5 | m2\|\|m1 = 2⁽⁸*^{size)-1}−1 | // m1, m2 are 64-bit |

| | | |
|---|---|---|
| 6 | Vd[63:0] = m1 & (flags \| PDEP(Vn, mask)); | // PDEP op from HSW BMI |

| | |
|---|---|
| 7 | Vd[127:64] = m2 & (flags \| PDEP(Vn >> 56, mask)); |

LISTING 9 shows pseudocode corresponding to one embodiment of a 64-bit varint size decode instruction using an Arm microarchitecture.

LISTING 9

| | | |
|---|---|---|
| A64_varint64_Decode_size_VFP | Vd.1D, Vm.16B | // Throws Fault |

| | |
|---|---|
| 1 | //dst is low 64-bits of vector register, source is 128-bit return a number <= 10 |
| 2 | for(size=1; size<=16; size++){ |

| | |
|---|---|
| 3 | if((Vm[size−1] & 0x80)==0) break; // Vm is viewed as an array of 16 bytes |

| | |
|---|---|
| 4 | } |
| 5 | if (size > 10) return error // or set condition-codes such as VCNZ |
| 6 | Vd[63:0] = size; |

The foregoing instruction may also be implemented using Xd as the destination (e.g., a 64-bit GPR).

LISTING 10 shows pseudocode corresponding to one embodiment of a 64-bit varint decode instruction using an Arm microarchitecture.

LISTING 10

| | |
|---|---|
| A64_varint64_Decode_VFP | Vd.1D, Vn.1Q, Vm.1D |

| | |
|---|---|
| 1 | // dst is low 64-bits of vector register, |
| 2 | // Vn is128-bits, contains the encoded integer |
| 3 | // Low 64-bits of vector register Vm has size |
| 4 | // 64-bit Constants mask = 0x7f7f7f7f7f7f..., |
| 5 | size = Vm; |

| | |
|---|---|
| 6 | m2\|\|m1 = 2⁽⁸*^{size)}−1 // m1, m2 are 64-bit |
| 7 | value1 = m1 & PEXT(Vn[63:0], mask) // PEXT op from BMI₂ |
| 8 | value2 = m2 & PEXT(Vn[127:64], mask) |
| 9 | Vd[63:0] = (value2<<56) \| value1 |

An example of generating a byte-packed encoded varint byte stream using the novel encode Arm-based ISA instructions disclosed herein is illustrated in FIGS. 10a-10d. In this example, a sequence of four varints 10592663, 2979112352, 9776547 and 7039567833107374484 are encoded using the A64_varint64_encode_size_VFP and A64_varint64_encode_VFP instructions, which are implemented to process each of the varints. The other variants of these instructions described herein may be implemented in a similar manner.

The process begins in the state shown in FIG. 10a, under which a first varint 1000 having a decimal value of 10592663 is received, encoded, and adding to an encoded byte stream. Generally, on a 64-bit processor, each varint will be received as a 64-bit binary value, such as depicted by 64-bit unencoded binary format 1002. Execution of the A64_varint64_encode_size_VFP and A64_varint64_encode_VFP instructions will produce an encoded varint 1004, which is added to an encoded byte stream 1006 at the address pointed to by the dstptr.

For simplicity and clarity, encoded byte stream 1006 is depicted as three sequential 8-byte (64-bit) cachelines that have been cleared (i.e., each 64-bit cacheline is all ‘0’s). As shown, bytes 0:7 of encoded varint 1004 are written to encoded byte stream 1006, which include bytes 0:3 containing the encoded varint bits as a four byte sequence 1008, and the remaining bytes 4:7, which are written as all ‘0’s. The dstprt is then advanced by four bytes, which is the encode size of 10592663. In one embodiment, either 8 bytes (bytes 0:7) or 16 bytes (0:7) and (8:15) are written to the stream, depending on whether the size of the encoded varint is 8 bytes or less.

Processing of the second varint 1010, which has a decimal value of 2979112352 and an uncoded binary format 1012, is shown in FIG. 10b. Execution of the A64_varint64_encode_size_VFP and A64_varint64_encode_VFP instructions will produce an encoded varint 1014, which is added to an encoded byte stream 1006 at the address pointed to by the dstptr. As before, bytes 0:7 of the encoded varint 1014 are sequentially written to byte stream 1006, depicted as including a first portion 1016a of four bytes 0:3 and a second portion 1016b of a single byte :4. (It is noted that bytes 0:4 would simply be written to the encoded byte stream as the next five bytes; the reason for splitting it up in FIG. 10b is due to drawing size constraints.) The dstprt is then advanced by 5 bytes, which is the encode size of 2979112352.

Processing of the third varint 1018, which has a decimal value of 9776547 and an uncoded binary format 1020, is shown in FIG. 10c. Execution of the A64_varint64_encode_size_VFP and A64_varint64_encode_VFP instructions will produce encoded varint 1022, which is added to an encoded byte stream 1006 at the address pointed to by the dstptr. As before, bytes 0:7 of encoded varint 1022 are sequentially written to byte stream 1006, including bytes 0:3 depicted as a four byte sequence 1024, while the remaining bytes 4:7 are all 0's. The dstprt is then advanced by 4 bytes, which is the encode size of 9776547.

Processing of the fourth varint 1026, which has a decimal value of 7039567833107374484 and an uncoded binary format 1028, is shown in FIG. 10d. Execution of the A64_varint64_encode_size_VFP and A64_varint64_encode_VFP instructions will produce encoded varint 1030, which is added to an encoded byte stream 1006 at the address pointed to by the dstptr. In this instance, the encoded varint has a size greater than 8 bytes, thus bytes 0:15 are added to encoded byte stream 1006. This includes bytes 0:9 of encoded varint 1030 are sequentially written to byte stream 1006, depicted as a bytes 0:2 portion 1032a and bytes 3:9 portion 1032b. The dstprt is then advanced by 10 bytes, which is the encode size of 7039567833107374484.

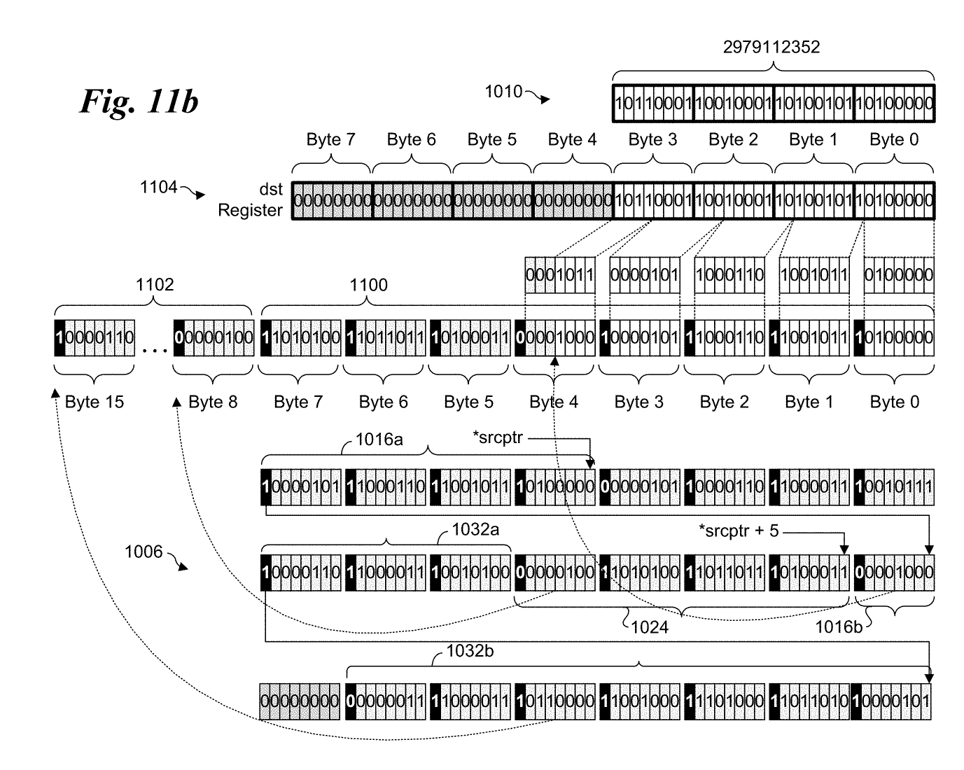

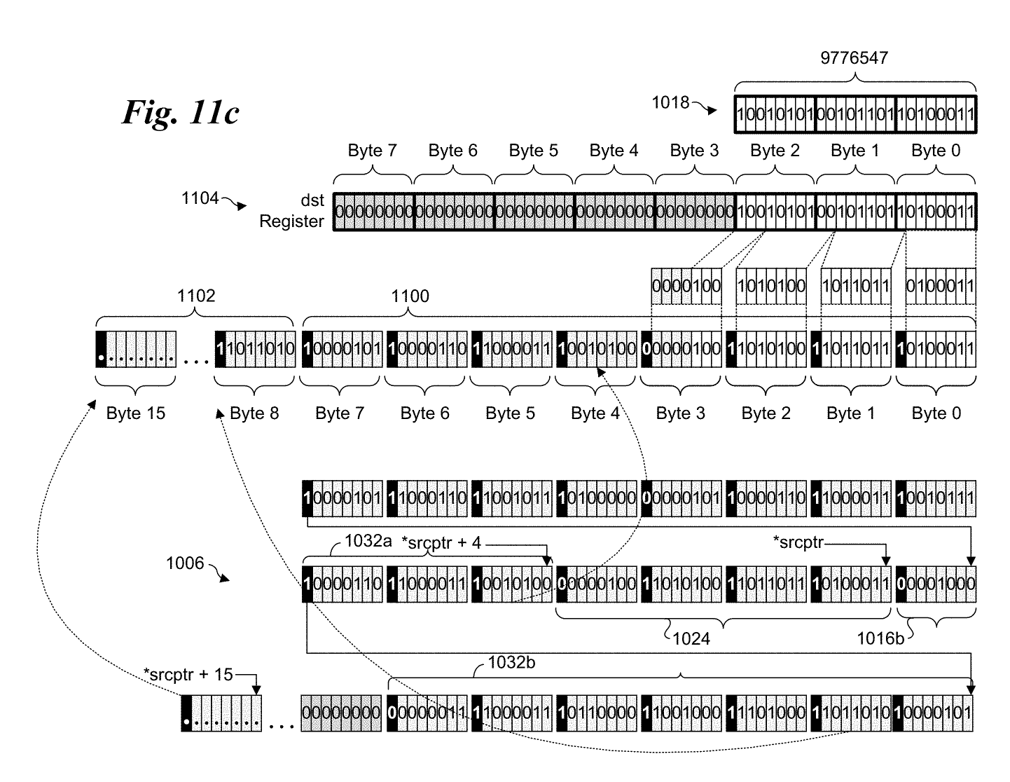

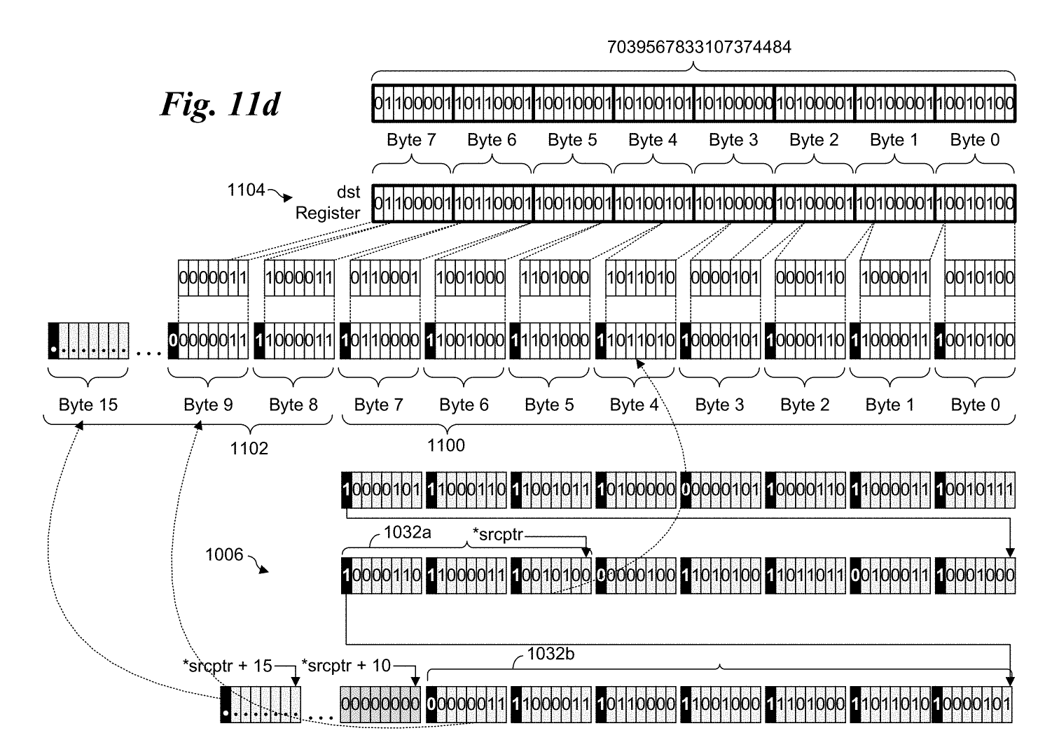

On the receiving endpoint of a message containing a portion (or all of) an encoded byte stream, decoding operations are performed to return the encoded varints back to their original unencoded integer form. Continuing with the current example, corresponding decode operations for decoding the encoded formats of varints 10592663, 2979112352, 9776547 and 7039567833107374484 using the A64_varint64_Decode_size_VFP and A64_varint64_Decode_VFP instructions are depicted in FIGS. 11a-11d, respectively.

On one level, decoding an encoded byte stream performs an inverse operation to that performed to encode the byte stream. However, a noticeable difference is that an the encode varint size and encode varint instructions only operate on one 64-bit (8-byte) varint at a time, while the varint decode size and varint decode instructions operate on the next 128 bits in the encoded byte stream, since it is possible that an encoded varint may have a size larger than 8 bytes.

As shown in FIG. 11a, execution of an A64_varint64_Decode_size_VFP instruction copies the next 16 bytes of encoded byte stream 1006 beginning at the current position of the srcptr into local registers 1100 and 1102, as depicted by bytes 0:7 and 8:15. In a manner similar to the varint64_Decode_size instruction discussed above, the A64_varint64_Decode_size_VFP instruction evaluates each byte in sequence, starting at byte 0, until it finds a ‘0’ in the most significant bit of the byte, incrementing a size variable with each loop iteration. As shown in FIG. 11a, the A64_varint64_Decode_size_VFP instruction determines the encoded size is 4 bytes, which is used as the size input to the A64_varint64_Decode_VFP instruction, which is executed next. The A64_varint64_Decode_VFP instructions operates on these 4 bytes, skipping the most significant bit of each byte to generate a decoded bit pattern that is written to destination (dst) register 1104. The first decoded varint is 10592663, which is the same as the first varint that was encoded in FIG. 10a. The scrptr is then advanced by the size of the first encoded varint, which is 4 bytes. (It is noted the scrptr may be advanced one byte at a time as each byte in the encoded byte stream is processed—for simplicity the advancement of the scrptr is illustrated in FIGS. 11a-11d as a single operation.)

The decoding of the second encoded varint is shown in FIG. 11b. As before, execution of the A64_varint64_Decode_size_VFP instruction copies the next 16 bytes of encoded byte stream 1006 beginning at the current position of the srcptr into local registers 1100 and 1102. The A64_varint64_Decode_size_VFP instruction determines the encoded size is 5 bytes, which is used as the size input to the A64_varint64_Decode_VFP instruction, which is executed next. The A64_varint64_Decode_VFP instruction operates on the 5 bytes, skipping the most significant bit of each byte to generate a decoded bit pattern that is written to destination (dst) register 1104. The second decoded varint is 2979112352, which is same as the second varint that was encoded in FIG. 10b. The scrptr is then advanced by the size of the second encoded varint, which is 5 bytes.

The decoding of the third encoded varint is shown in FIG. 11c. As before, execution of the A64_varint64_Decode_size_VFP instruction copies the next 16 bytes of encoded byte stream 1006 beginning at the current position of the srcptr into local registers 1100 and 1102. The A64_varint64_Decode_size_VFP instruction determines the encoded size is 4 bytes, which is used as the size input to the A64_varint64_Decode_VFP instruction, which operates on the 4 bytes, skipping the most significant bits of each byte to generate a decoded bit pattern that is written to destination (dst) register 1104. The third decoded varint is 9776547, which is the same as the third varint that was encoded in FIG. 10c. The scrptr is then advanced by 4 bytes, the size of the third encoded varint.

The decoding of the forth encoded varint is shown in FIG. 11d. Execution of the A64_varint64_Decode_size_VFP instruction copies the next 16 bytes of encoded byte stream 1006 beginning at the current position of the srcptr into local registers 1100 and 1102. The A64_varint64_Decode_size_VFP instruction determines the encoded size is 10 bytes, which is used as the size input to the A64_varint64_Decode_VFP instruction. As illustrated, the A64_varint64_Decode_VFP instruction operations on bytes 0:9, requiring access to data from both registers 1100 and 1102, skipping the most significant bit of each byte of each byte to generate a decoded bit pattern that is written to destination (dst) register 1104. The fourth decoded varint is 7039567833107374484, which is the same as the fourth varint that was encoded in FIG. 10c. The scrptr is then advanced by 10 bytes, the size of the forth encoded varint. The decode process would then continue in a similar manner to process the rest of the encoded byte stream (not shown)

The novel varint encode and decode instructions disclosed herein will provide a significant improvements in processing variable-length integers, such as used by Google's Protobuf messages. Under a conventional approach, software instructions for encoding and decoding a varint byte stream would be written as source code in a language such as C++, Java, Python, etc., and compiled by a compiler for a target processor architecture, which would generate numerous machine level (e.g., ISA) instructions that could be executed by a processor having the target processor architecture. Conversely, for a processor employing a set of the varint encode and decode instructions in its ISA, the compiler would generate substantially less machine-level instructions, since a single instruction could be used in place of dozens of instructions that would result from compiling an entire method or function for encoding or decoding a varint written at the source code level. Moreover, in some embodiments, encoding or decoding both the size of a varint and the varint itself may be done in a single instruction, as described above. In turn, at the source code level the language could include a single instruction to encode or decode a varint—when those single instructions are compiled, corresponding machine-level code would be generated using the ISA varint instructions.

As described above, some embodiments may employ PDEP and PEXT ISA uops. For example, an ISA with existing support for PDEP and PEXT may be extended to support the new instructions. Generally, the PDEP and PEXT instructions may be implemented using microcode, or the entire pseudocode may be implemented as circuits. For example, in some embodiments, the same operations performed via PDEP and PEXT instructions may be implemented with circuits in the data-path.

As discussed above, when considering whether implement an instruction using microcode or circuitry, there is usually a tradeoff of area/complexity to performance. For example, suppose you have a pseudo-code sequence that has 4 lines of code, assuming each line is reasonably simple in terms of operation (e.g. arithmetic, shifting . . . ). Under one embodiment, existing ALU circuits in an ISA are re-used. Under this approach, when an instruction for implementing the 4 lines of pseudocode decodes, it will trigger a micro-sequencer that will make it appear like 4 simpler instructions (uops) were executed corresponding to the 4 lines of pseudocode. In this case, the performance will be lower, as the ALUs will be used up for 4 cycles for this instruction. Another instruction of this type can only issue after 4 cycles. Optionally, new circuits are added to the pipeline. The simplest way to visualize this approach is each line of pseudocode becomes one pipe-stage. Performance will be higher, since for each cycle, a new instruction of this type can be issued into the pipeline. As yet another option, a combination of microcode and circuitry may be used to implement the new instructions disclosed herein.

Further aspects of the subject matter described herein are set out in the following numbered clauses:

1. A processor, comprising:
at least one of circuitry and logic configured to implement a set of instructions that are part of an instruction set architecture (ISA) for the processor, the set of instructions relating to encoding and decoding variable-length integers (varints), the set of instructions including,
a varint size encode instruction to encode a size of a varint;
a varint encode instruction to encode a varint;
a varint size decode instruction to decode a size of an encoded varint; and
a varint decode instruction to decode an encoded varint.

2. The processor of clause 1, wherein the varint size encode instruction comprises:
an opcode identifying the instruction as a varint size encode instruction;
a source operand identifying a source register in which a varint is stored; and
a destination operand identifying a destination register in which a result of the varint size encode instruction is to be written.

3. The processor of clause 1 or 2, wherein the varint size encode instruction, when executed, performs operations comprising:
identifying an integer index of a most significant set bit in the varint;
multiplying the integer index by 9, adding 73, and bit shifting the result by 6.

4. The processor of any of the preceding clauses, where the varint encode instruction comprises:
an opcode identifying the instruction as a varint encode instruction;
a first operand comprising a destination pointer (dstptr)
a second operand comprising a source register in which one of 64 bits or 128 bits of a source varint are stored; and
a third operand comprising a register in which a size of the varint is stored.

5. The processor of any of the preceding clauses, wherein the varint encode instruction, when executed, performs operations comprising:
converting a varint into a variable-length quantity (VLQ) encoding including one or more VLQ octets.

6. The processor of any of the preceding clauses, wherein the ISA includes a Parallel Bits Deposit (PDEP) instruction, and the varint encode instruction, when executed, employs at least one PDEP instruction, each PDEP instruction including a source operand corresponding to an original or bit-shifted portion of the varint and a second operand comprising a mask having a pattern of 0x7f7f7f7f . . .

7. The processor of clause 6, wherein the varint encode instruction, when executed, performs operations comprising:
performing a first PDEP operation on a source comprising the varint and the mask;
logically OR'ing a result of the first PDEP operation with a flags constant having a pattern of 0x80808080 . . . , and storing the result in a destination;
performing a second PDEP operation on the source bit-shifted 56 bits and the mask;
logically OR'ing a result of the second PDEP operation with a flags constant having a pattern of 0x80808080 . . . , and storing the result at an address that is offset 8 bytes from a start of the destination; and
setting a most significant bit (MSB) of a byte that is offset n bytes from the start of the destination, where n is equal to a size of the varint in bytes.

8. The processor of any of the preceding clauses, wherein the varint size decode instruction comprises:
an opcode identifying the instruction as a varint size decode instruction;
a destination operand identifying a destination register in which a result of the varint size decode instruction is to be written; and
a source pointer to a location of an encoded varint to be decoded by the varint size decode instruction.

9. The processor of clause 8, wherein the varint size decode instruction, when executed, performs operations comprising:
beginning with a first byte of an encoded varint, evaluating each of one or more sequential bytes until it is determined a most significant bit of a byte being evaluated is a ‘0’; and
storing a size of the varint in bytes in a destination register, the size being equal to a number of bytes that were evaluated;

10. The processor of any of the preceding clauses, where the varint decode instruction comprises:
an opcode identifying the instruction as a varint decode instruction;
a first operand comprising a destination at which to write a result of the varint decode instructions
a source pointer to a location of an encoded varint to be decoded by the varint decode instruction; and
a third operand identifying a register in which a size of the varint is stored.

11. The processor of any of the preceding clauses, wherein the varint decode instruction, when executed, performs operations comprising:
converting a source varint encoded using a variable-length quantity (VLQ) encoding including one or more VLQ octets into an integer.

12. The processor of any of the preceding clauses, wherein the ISA includes a Parallel bits extract (PEXT) instruction, and the varint decode instruction, when executed, employs at least one PEXT instruction, each PEXT instruction including a source operand comprising a respective portion of an encoded varint and a second operand comprising a mask having a pattern of 0x7f7f7f7f . . .

13. The processor of clause 12, wherein the varint decode instruction, when executed, performs operations comprising:
performing a first PEXT operation on a lower portion of the encoded varint and the mask;
logically AND'ing a result of the first PEXT operation with a value ml on a bitwise basis to generate a first value1, where

m1=2^{(8*size)}−1;
performing a second PXET operation on an upper portion of the encoded varint and the mask;

logically AND'ing a result of the second PEXT operation with a value m2 on a bitwise basis to generate a second value2, where

m2=2^{(8*size)}−1;
bit-shifting bits in value2 56 bits to the left to create a bit-shifted value2; and
logically OR'ing value1 with the bit-shifted value2.

14. The processor of any of the preceding clauses, wherein the processor employs an Arm-based microarchitecture.

15. The processor of any of the preceding clauses, wherein the processor employs an x86-based microarchitecture.

16. The processor of any of the preceding clauses, wherein the at least one of circuitry and logic configured to implement the set of instructions does not include microcode.

17. The processor of any of the preceding clauses, wherein the at least one of circuitry and logic configured to implement the set of instructions includes microcode.

18. A non-transitory machine-readable medium, having semiconductor design data stored thereon defining circuitry and logic for an instruction set architecture (ISA) in a processor, the ISA including a set of instructions relating to encoding and decoding variable-length integers (varints), the set of instructions including,
a varint size encode instruction to encode a size of a varint;
a varint encode instruction to encode a varint;
a varint size decode instruction to decode a size of an encoded varint; and
a varint decode instruction to decode an encoded varint.

19. The non-transitory machine-readable medium of clause 18, wherein the varint size encode instruction comprises:
an opcode identifying the instruction as a varint size encode instruction;
a source operand identifying a source register in which a varint is stored; and
a destination operand identifying a destination register in which a result of the varint size encode instruction is to be written.

20. The non-transitory machine-readable medium of clause 18 or 19, wherein the varint size encode instruction, when executed, performs operations comprising:
identifying an integer index of a most significant set bit in the varint;
multiplying the integer index by 9, adding 73, and bit shifting the result by 6.

21. The non-transitory machine-readable medium of any of clauses 18-20, where the varint encode instruction comprises:
an opcode identifying the instruction as a varint encode instruction;
a first operand comprising a destination pointer (dstptr)
a second operand comprising a source register in which one of 64 bits or 128 bits of a source varint are stored; and
a third operand comprising a register in which a size of the varint is stored.

22. The non-transitory machine-readable medium of any of clauses 18-21, wherein the varint encode instruction, when executed, performs operations comprising:
converting a varint into a variable-length quantity (VLQ) encoding including one or more VLQ octets.

23. The non-transitory machine-readable medium of clause 18, wherein the ISA includes a Parallel Bits Deposit (PDEP) instruction, and the varint encode instruction, when executed, employs at least one PDEP instruction, each PDEP instruction including a source operand corresponding to an original or bit-shifted portion of the varint and a second operand comprising a mask having a pattern of 0x7f7f7f7f . . .

24. The non-transitory machine-readable medium of clause 23, wherein the varint encode instruction, when executed, performs operations comprising:
performing a first PDEP operation on a source comprising the varint and the mask;
logically OR'ing a result of the first PDEP operation with a flags constant having a pattern of 0x80808080 . . . , and storing the result in a destination;
performing a second PDEP operation on the source bit-shifted 56 bits and the mask;
logically OR'ing a result of the second PDEP operation with a flags constant having a pattern of 0x80808080 . . . , and storing the result at an address that is offset 8 bytes from a start of the destination; and
setting a most significant bit (MSB) of a byte that is offset n bytes from the start of the destination, where n is equal to a size of the varint in bytes.

25. The non-transitory machine-readable medium of any of clauses 18-24, wherein the varint size decode instruction comprises:
an opcode identifying the instruction as a varint size decode instruction;
a destination operand identifying a destination register in which a result of the varint size decode instruction is to be written; and
a source pointer to a location of an encoded varint to be decoded by the varint size decode instruction.

26. The non-transitory machine-readable medium of clause 25, wherein the varint size decode instruction, when executed, performs operations comprising:
beginning with a first byte of an encoded varint, evaluating each of one or more sequential bytes until it is determined a most significant bit of a byte being evaluated is a ‘0’; and
storing a size of the varint in bytes in a destination register, the size being equal to a number of bytes that were evaluated;

27. The non-transitory machine-readable medium of any of clauses 18-26, where the varint decode instruction comprises:
an opcode identifying the instruction as a varint decode instruction;
a first operand comprising a destination at which to write a result of the varint decode instructions
a source pointer to a location of an encoded varint to be decoded by the varint decode instruction; and
a third operand identifying a register in which a size of the varint is stored.

28. The non-transitory machine-readable medium of any of clauses 18-27, wherein the varint decode instruction, when executed, performs operations comprising:
converting a source varint encoded using a variable-length quantity (VLQ) encoding including one or more VLQ octets into an integer.

29. The non-transitory machine-readable medium of any of clauses 18-28, wherein the ISA includes a Parallel bits extract (PEXT) instruction, and the varint decode instruction, when executed, employs at least one PEXT instruction, each PEXT instruction including a source operand comprising a respective portion of an encoded varint and a second operand comprising a mask having a pattern of 0x7f7f7f7f . . .

30. The non-transitory machine-readable medium of clause 29, wherein the varint decode instruction, when executed, performs operations comprising:
performing a first PEXT operation on a lower portion of the encoded varint and the mask;
logically AND'ing a result of the first PEXT operation with a value ml on a bitwise basis to generate a first value1, where

m1=2^{(8*size)}−1;
performing a second PXET operation on an upper portion of the encoded varint and the mask; logically AND'ing a result of the second PEXT operation with a value m2 on a bitwise basis to generate a second value2, where

m2=2^{(8*size)}−1;
bit-shifting bits in value2 56 bits to the left to create a bit-shifted value2; and logically OR'ing value1 with the bit-shifted value2.

31. The non-transitory machine-readable medium of any of clauses 18-30, wherein the processor employs an Arm-based microarchitecture.

32. The non-transitory machine-readable medium of any of clauses 18-31, wherein the processor employs an x86-based microarchitecture.

33. A method, comprising:
encoding, via a processor including an instruction set architecture (ISA), a first plurality of integers having variable lengths (varints) into a first encoded varint byte stream in which, for each varint, an integer value of the varint is encoded; and
decoding, via a processor, a second encoded varint byte stream including a second plurality of encoded varints, to convert each encoded varint into an integer value,
wherein each varint is encoded using a varint encode instruction that is implemented as part of the ISA of the processor, and wherein the second encoded varint byte stream is decoded using a varint decode instruction that is part of the ISA of the processor.

34. The method of clause 33, further comprising:
encoding, using a varint encode size instruction that is part of the ISA of the processor, a size in bytes of each of the first plurality of varints in the first encoded varint byte stream.

35. The method of clause 34, wherein the varint size encode instruction comprises:
an opcode identifying the instruction as a varint size encode instruction;
a source operand identifying a source register in which a varint is stored; and
a destination operand identifying a destination register in which a result of the varint size encode instruction is to be written.

36. The method of clause 33 or 34, wherein the varint size encode instruction, when executed, performs operations comprising:
for each of the first plurality of varints,
identifying an integer index of a most significant set bit in the varint;
multiplying the integer index by 9, adding 73, and bit shifting the result by 6.

37. The method of clause 33 wherein a size in bytes of each of the encoded varints in the first encoded varint byte stream is encoded using the varint encode instruction.

38. The method of any of clauses 33-37, where the varint encode instruction comprises:
an opcode identifying the instruction as a varint encode instruction;
a first operand comprising a destination pointer (dstptr)
a second operand comprising a source register in which one of 64 bits or 128 bits of a source varint are stored; and
a third operand comprising a register in which a size of the varint is stored.

39. The method of any of clauses 33-38, wherein the varint encode instruction, when executed, converts a varint into a variable-length quantity (VLQ) encoding including one or more VLQ octets.

40. The method of any of clauses 33-39, wherein the ISA includes a Parallel Bits Deposit (PDEP) instruction, and the varint encode instruction, when executed, employs at least one PDEP instruction, each PDEP instruction including a source operand corresponding to an original or bit-shifted portion of the varint and a second operand comprising a mask having a pattern of 0x7f7f7f7f . . .

41. The method of clause 40, wherein the varint encode instruction, when executed, performs operations comprising:
performing a first PDEP operation on a source comprising the varint and the mask;
logically OR'ing a result of the first PDEP operation with a flags constant having a pattern of 0x80808080 . . . , and storing the result in a destination;
performing a second PDEP operation on the source bit-shifted 56 bits and the mask;
logically OR'ing a result of the second PDEP operation with a flags constant having a pattern of 0x80808080 . . . , and storing the result at an address that is offset 8 bytes from a start of the destination; and
setting a most significant bit (MSB) of a byte that is offset n bytes from the start of the destination, where n is equal to a size of the varint in bytes.

42. The method of any of clauses 33-41, wherein each of the decoded varints in the second encoded varint byte stream includes an encoded size, and wherein the method further comprises:
for each encoded varint,
decoding a size of the encoded varint using a varint decode size instruction that is part of the ISA of the processor; and
decoding the encoded varint using a varint decode instruction that is part of the ISA of the processor.

43. The method of clause 42, wherein the varint size decode instruction comprises:
an opcode identifying the instruction as a varint size decode instruction;
a destination operand identifying a destination register in which a result of the varint size decode instruction is to be written; and
a source pointer to a location of an encoded varint to be decoded by the varint size decode instruction.

44. The method of clause 43, wherein the varint size decode instruction, when executed, performs operations comprising:
beginning with a first byte of an encoded varint, evaluating each of one or more sequential bytes until it is determined a most significant bit of a byte being evaluated is a ‘0’; and
storing a size of the varint in bytes in a destination register, the size being equal to a number of bytes that were evaluated;

45. The method of any of clauses 33-44, where the varint decode instruction comprises:
an opcode identifying the instruction as a varint decode instruction;
a first operand comprising a destination at which to write a result of the varint decode instructions
a source pointer to a location of an encoded varint to be decoded by the varint decode instruction; and
a third operand identifying a register in which a size of the varint is stored.

46. The method of any of clauses 33-45, wherein the varint decode instruction, when executed, converts a source varint encoded using a variable-length quantity (VLQ) encoding including one or more VLQ octets into an integer.

47. The method of any of clauses 33-46, wherein the ISA includes a Parallel bits extract (PEXT) instruction, and the varint decode instruction, when executed, employs at least one PEXT instruction, each PEXT instruction including a source operand comprising a respective portion of an encoded varint and a second operand comprising a mask having a pattern of 0x7f7f7f7f . . .

48. The method of clause 47, wherein the varint decode instruction, when executed, performs operations comprising:
performing a first PEXT operation on a lower portion of the encoded varint and the mask;
logically AND'ing a result of the first PEXT operation with a value ml on a bitwise basis to generate a first value1, where

m1=2^{(8*size)}−1;
performing a second PXET operation on an upper portion of the encoded varint and the mask;
logically AND'ing a result of the second PEXT operation with a value m2 on a bitwise basis to generate a second value2, where

m2=2^{(8*size)}−1;
bit-shifting bits in value2 56 bits to the left to create a bit-shifted value2; and
logically OR'ing value1 with the bit-shifted value2.

49. The method of any of clauses 33-48, wherein the processor employs an Arm-based microarchitecture.

50. The method of any of clauses 33-48, wherein the processor employs an x86-based microarchitecture.

51. The method of any of clauses 33-50, wherein each of the varints has an unencoded size in bytes ranging from 1 to 8 bytes.

52. The method of any of clauses 33-51, wherein each of the first and second encoded varint byte streams employ a Little endian byte order.

53. The method of any of clauses 33-51, wherein each of the first and second encoded varint byte streams employ a Big endian byte order.

In addition, embodiments of the present description may be implemented not only within a semiconductor chip such as a processor of SoC, but also within machine-readable media. For example, the designs described above may be stored upon and/or embedded within machine readable media associated with a design tool used for designing semiconductor devices. Examples include a netlist formatted in the VHSIC Hardware Description Language (VHDL) language, Verilog language or SPICE language. Some netlist examples include: a behavioral level netlist, a register transfer level (RTL) netlist, a gate level netlist and a transistor level netlist. Machine-readable media also include media having layout information such as a GDS-II file. Furthermore, netlist files or other machine-readable media for semiconductor chip design may be used in a simulation environment to perform the methods of the teachings described above.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a computer-readable or machine-readable non-transitory storage medium. A computer-readable or machine-readable non-transitory storage medium includes any mechanism for storing or transmitting information in a form readable by a machine (e.g., a computer). For example, a computer-readable or machine-readable non-transitory storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer-readable or machine-readable non-transitory storage medium may also include a storage or database from which content can be downloaded. The computer-readable or machine-readable non-transitory storage medium may also include a device or product having content stored thereon at a time of sale or delivery. Thus, delivering a device with stored content, or offering content for download over a communication medium may be understood as providing an article of manufacture comprising a computer-readable or machine-readable non-transitory storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including computer-readable or machine-readable non-transitory storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings.

Rather, the scope of the invention is to be determined entirely by the following claims, which are to be construed in accordance with established doctrines of claim interpretation.

What is claimed is:

1. A processor, comprising:
at least one of circuitry and logic configured to implement a set of instructions that are part of an instruction set architecture (ISA) for the processor, the set of instructions relating to encoding and decoding variable-length integers (varints), the set of instructions including,
a varint size encode instruction to encode a size of a varint;
a varint encode instruction to encode a varint;
a varint size decode instruction to decode a size of an encoded varint; and
a varint decode instruction to decode an encoded varint.

2. The processor of claim 1, wherein the varint size encode instruction comprises:
an opcode identifying the instruction as a varint size encode instruction;
a source operand identifying a source register in which a varint is stored; and
a destination operand identifying a destination register in which a result of the varint size encode instruction is to be written.

3. The processor of claim 1, where the varint encode instruction comprises:
an opcode identifying the instruction as a varint encode instruction;
a first operand comprising a destination pointer (dstptr)
a second operand comprising a source register in which one of 64 bits or 128 bits of a source varint are stored; and
a third operand comprising a register in which a size of the varint is stored.

4. The processor of claim 1, wherein the varint encode instruction, when executed, performs operations comprising:
converting a varint into a variable-length quantity (VLQ) encoding including one or more VLQ octets.

5. The processor of claim 1, wherein the ISA includes a Parallel Bits Deposit (PDEP) instruction, and the varint encode instruction, when executed, employs at least one PDEP instruction, each PDEP instruction including a source operand corresponding to an original or bit-shifted portion of the varint and a second operand comprising a mask having a pattern of 0x7f7f7f7f . . .

6. The processor of claim 1, wherein the varint size decode instruction comprises:
an opcode identifying the instruction as a varint size decode instruction;
a destination operand identifying a destination register in which a result of the varint size decode instruction is to be written; and
a source pointer to a location of an encoded varint to be decoded by the varint size decode instruction.

7. The processor of claim 6, wherein the varint encode instruction, when executed, performs operations comprising:
beginning with a first byte of an encoded varint, evaluating each of one or more sequential bytes until it is determined a most significant bit of a byte being evaluated is a ‘0’; and
storing a size of the varint in bytes in a destination register, the size being equal to a number of bytes that were evaluated.

8. The processor of claim 1, where the varint decode instruction comprises:
an opcode identifying the instruction as a varint decode instruction;
a first operand comprising a destination at which to write a result of the varint decode instructions
a source pointer to a location of an encoded varint to be decoded by the varint decode instruction; and
a third operand identifying a register in which a size of the varint is stored.

9. The processor of claim 1, wherein the processor employs an Arm-based microarchitecture.

10. The processor of claim 1, wherein the processor employs an x86-based microarchitecture.

11. A non-transitory machine-readable medium, having semiconductor design data stored thereon defining circuitry and logic for an instruction set architecture (ISA) in a processor, the ISA including a set of instructions relating to encoding and decoding variable-length integers (varints), the set of instructions including,
a varint size encode instruction to encode a size of a varint;
a varint encode instruction to encode a varint;
a varint size decode instruction to decode a size of an encoded varint; and
a varint decode instruction to decode an encoded varint.

12. The non-transitory machine-readable medium of claim 11, wherein the varint size encode instruction comprises:
an opcode identifying the instruction as a varint size encode instruction;
a source operand identifying a source register in which a varint is stored; and
a destination operand identifying a destination register in which a result of the varint size encode instruction is to be written.

13. The non-transitory machine-readable medium of claim 11, where the varint encode instruction comprises:
an opcode identifying the instruction as a varint encode instruction;
a first operand comprising a destination pointer (dstptr)
a second operand comprising a source register in which one of 64 bits or 128 bits of a source varint are stored; and
a third operand comprising a register in which a size of the varint is stored.

14. The non-transitory machine-readable medium of claim 11, wherein the varint encode instruction, when executed, performs operations comprising:
converting a varint into a variable-length quantity (VLQ) encoding including one or more VLQ octets.

15. The non-transitory machine-readable medium of claim 11, wherein the ISA includes a Parallel Bits Deposit (PDEP) instruction, and the varint encode instruction, when executed, employs at least one PDEP instruction, each PDEP instruction including a source operand corresponding to an original or bit-shifted portion of the varint and a second operand comprising a mask having a pattern of 0x7f7f7f7f . . .

16. The non-transitory machine-readable medium of claim 11, wherein the varint size decode instruction comprises:
an opcode identifying the instruction as a varint size decode instruction;
a destination operand identifying a destination register in which a result of the varint size decode instruction is to be written; and
a source pointer to a location of an encoded varint to be decoded by the varint size decode instruction.

17. The non-transitory machine-readable medium of claim 16, wherein the varint encode instruction, when executed, performs operations comprising:
beginning with a first byte of an encoded varint, evaluating each of one or more sequential bytes until it is determined a most significant bit of a byte being evaluated is a ‘0’; and
storing a size of the varint in bytes in a destination register, the size being equal to a number of bytes that were evaluated.

18. The non-transitory machine-readable medium of claim 11, where the varint decode instruction comprises:
an opcode identifying the instruction as a varint decode instruction;
a first operand comprising a destination at which to write a result of the varint decode instructions
a source pointer to a location of an encoded varint to be decoded by the varint decode instruction; and
a third operand identifying a register in which a size of the varint is stored.

19. The non-transitory machine-readable medium of claim 11, wherein the varint decode instruction, when executed, performs operations comprising:
converting a source varint encoded using a variable-length quantity (VLQ) encoding including one or more VLQ octets into an integer.

20. The non-transitory machine-readable medium of claim 11, wherein the ISA includes a Parallel bits extract (PEXT) instruction, and the varint decode instruction, when executed, employs at least one PEXT instruction, each PEXT instruction including a source operand comprising a respective portion of an encoded varint and a second operand comprising a mask having a pattern of 0x7f7f7f7f . . .

21. The non-transitory machine-readable medium of claim 11, wherein the processor employs an Arm-based microarchitecture.

22. The non-transitory machine-readable medium of claim 11, wherein the processor employs an x86-based microarchitecture.

23. A method, comprising:
encoding, via a processor including an instruction set architecture (ISA), a first plurality of integers having variable lengths (varints) into a first encoded varint byte stream in which, for each varint, an integer value of the varint is encoded; and
decoding, via a processor, a second encoded varint byte stream including a second plurality of encoded varints, to convert each encoded varint into an integer value,
wherein each varint is encoded using a varint encode instruction that is implemented as part of the ISA of the processor, and wherein the second encoded varint byte stream is decoded using a varint decode instruction that is part of the ISA of the processor.

24. The method of claim 23, wherein a size in bytes of each of the encoded varints in the first encoded varint byte stream is encoded using a varint encode size instruction that is part of the ISA of the processor.

25. The method of claim 23 wherein a size in bytes of each of the encoded varints in the first encoded varint byte stream is encoded using the varint encode instruction.

26. The method of claim 23, wherein the processor employs an Arm-based microarchitecture.

27. The method of claim 23, wherein the processor employs an x86-based microarchitecture.

28. The method of claim 23, wherein each of the varints has an unencoded size in bytes ranging from 1 to 8 bytes.

29. The method of claim 23, wherein each of the first and second encoded varint byte streams employ a Big endian byte order.

30. The method of claim 23, wherein each of the first and second encoded varint byte streams employ a Little endian byte order.
